(19) United States
(12) Patent Application Publication
(10) Pub. No.: US 2008/0222443 A1
(43) Pub. Date: Sep. 11, 2008

(54) Controller

(75) Inventors: Paul Wallner, Prien (DE); Peter Gregorius, Muenchen (DE); Ralf Schledz, Zolling (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Muenchen (DE)

(21) Appl. No.: 11/813,952

(22) PCT Filed: Jan. 4, 2006
(86) PCT No.: PCT/EP06/00038

§ 371 Date: Mar. 17, 2008

(30) Foreign Application Priority Data
Jan. 14, 2005 (DE) 10 2005 001 892.0

(51) Int. Cl. G06F 1/08

(52) U.S. Cl. 713/502

(57) ABSTRACT

The invention relates to a controller for generating control signals (evload_o, odload_o, st_chgclk_o, clk_o , clkorfiford_i) synchronous with a continuous clock signal (clk_hr_i) input to it for a device (1) to be controlled synchronously with the clock signal (clk_hr_i), wherein the controller (SE) has: register means for registering at least one set signal (st_load_i, st_fiford_i), comprising a plurality of bit positions, counting means for counting edges of the clock signal (clk_hr_i) depending on one or a plurality of set signals respectively registered in the register means, and synchronization and output means for synchronizing a value counted by the counting means with the clock signal (clk_hr_i) and the registered set signal and outputting at least one of the control signals, wherein the register means, the counting means and the synchronization and output means are configured and connected to one another in such a way that the output control signal(s), depending on the respectively registered set signal, occupies (occupy) one of a plurality of temporal positions with a respective phase difference of an integral multiple of half a clock cycle synchronously with the leading or trailing edge of the clock signal. The controller can be applied in particular for controlling the synchronous parallel-serial converter for converting a parallel input signal comprising k bit positions into a serial output signal sequence synchronously with the clock signal (clk_hr_i), which converter is provided in a transmitting circuit in the interface circuit of a very fast DDR DRAM semiconductor memory component of the coming memory generation (e.g. DDR4).

The invention relates to a controller for generating control signals synchronous with a continuous clock signal input to it for a device to be controlled synchronously with the clock signal. This controller can be applied in particular for controlling a synchronous parallel-serial converter in the transmitting interface circuit of very fast DDR DRAM memories of the future memory generation.

In previous DDR DRAM semiconductor memories, the data, address and control signals and also clock signals were fed to the individual semiconductor memory components in each case via separate bus line systems.

Due to the considerably higher transmission rates (up to 7.2 Gbit/s per pin), in the DDR DRAM memories of the next generation that are currently in development (for example DDR4 or NMT (new memory technology)), data signals as well as address and control signals and also the clock signals will be transmitted via differential signal lines. For this reason, in the case of the conventional architecture of the memory transmitting and receiving interfaces, the number of pins for these signals would at least double. However, such an increased number of pins is not desirable or possible either in the case of the individual memory components (chips) or in the case of the memory modules that carry them.

In order to reduce the number of pins and since the data, address and control signals are transmitted unidirectionally, new transmitting and receiving interface circuits are being developed which transmit and receive the data, control and address signals to be transmitted within a frame (signal frame), that is to say in each case in a manner corresponding to a transmitting and receiving protocol synchronously with the clock signal likewise present, whilst complying with very strict temporal conditions. It goes without saying that these signals are likewise transmitted differentially, the clock signal being transmitted separately. Such protocol-oriented transmitting and receiving interface circuits require fast and clock-synchronous coding and decoding logics in the transmitting and receiving section of the memory interface, and also in the receiving section data and clock recovery.

In order to combine the data bits that are read out from the memory arrays and are to be transmitted into a data stream corresponding to the protocol, the transmitting part of the memory interface requires a parallel-serial conversion that converts the data read out in parallel from the memory arrays as a plurality of bits into a serial 1-bit data signal stream synchronously with the clock signal.

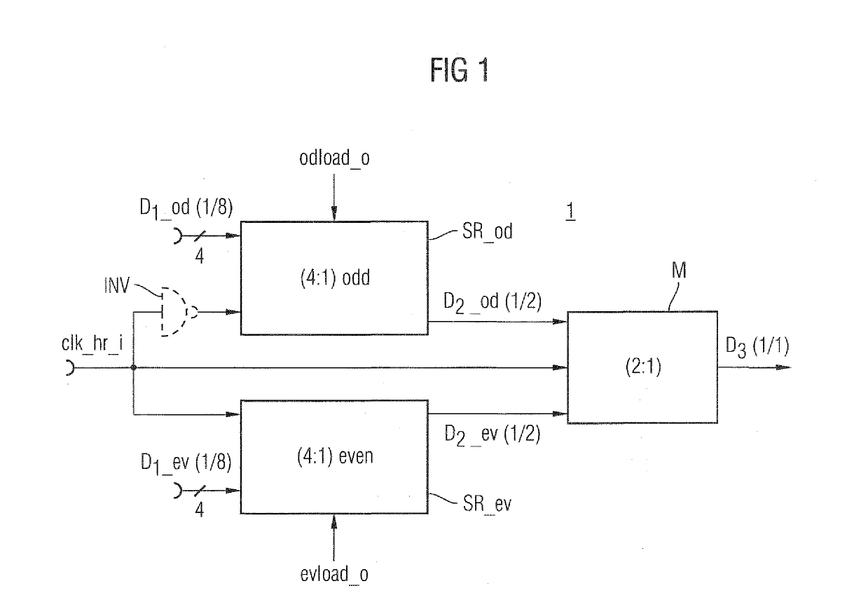

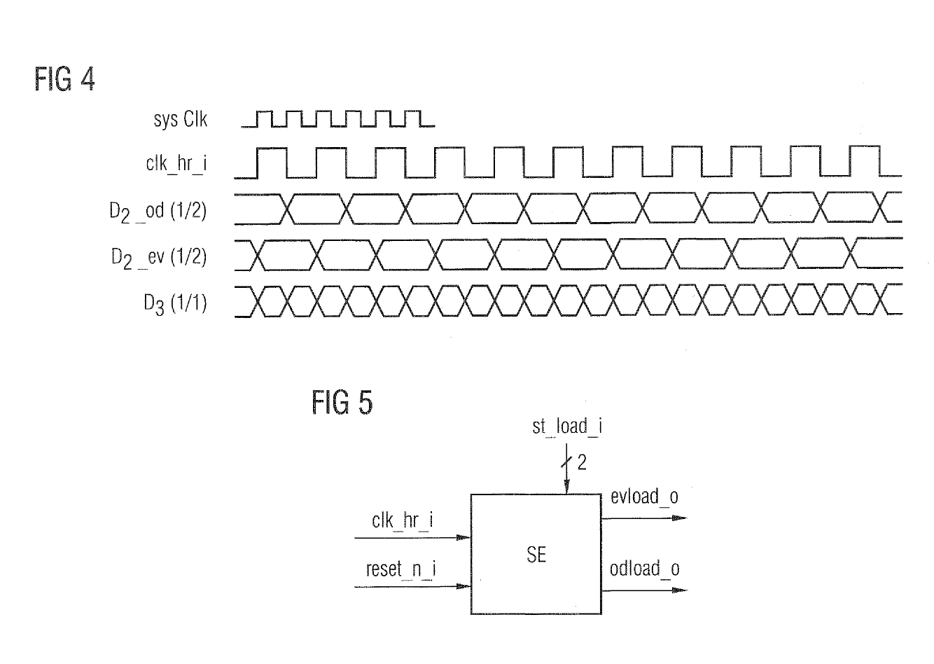

A basic construction and function of such an exemplary synchronous parallel-serial converter is explained below with reference to the accompanying FIGS. 1 to 4. The synchronous parallel-serial converter 1 illustrated schematically in the form of a function block diagram in FIG. 1 has a first (4:1) shift register SR_od and a second (4:1) shift register SR_ev and a (2:1) merging unit M. A data stream initially comprising eight bits arrives, having been divided into a data stream D1_od comprising the four odd bits and a data stream D1_ev comprising the four even bits, respectively at the first shift register SR_od and at the second shift register SR_ev. A half-rate clock clk_hr_i derived from a system clock sys_clk (not shown in FIG. 1) is likewise present at the units of the synchronous parallel-serial converter 1. The system clock sys_clk has a clock frequency double that of the half-rate clock clk_hr_i, but is only fictitious in the context of what is described here. In the first shift register SR_od, depending on a load signal odload_o, the odd parallel 4-bit part D1_od of the incoming data is converted, synchronously with the trailing (or leading) edge of the half-rate clock signal clk_hr_i, into a serial half-rate data stream D2_od comprising the odd bits of the input data signal. Moreover, in the second shift register SR_ev, the even portion D1_ev of the parallel 4-bit data signal is accepted with the second load signal evload_o and converted into a serial half-rate data stream D2_ev synchronously with the leading (or trailing) edge of the half-rate clock signal clk_hr_i. The two serial half-rate data streams D2_od and D2_ev output from the two shift registers SR_od and SR_ev are converted in the merging unit M, synchronously respectively with the clock trailing and leading edge, into a serial 1-bit output data stream D3 (1/1) having the same data rate as the system clock sys_clk from which the half-rate clock clk_hr_i is derived synchronously with half the clock rate e.g. by means of a PLL circuit. It should also be mentioned that FIG. 1 illustrates by dashed lines an inverter element INV, which can optionally be used, which can have the effect that the circuit construction of the first and second shift registers SR_od and SR_ev is identical in each case. It is furthermore noteworthy that, although this is not illustrated in FIG. 1, the half-rate clock signal clk_hr_i can be present as a differential clock signal and can also be fed with a MOS level. If the clock signal clk_hr_i is fed differentially, the inverter element INV is obviated because positive and negative phases can be interchanged instead of the inverter element INV. It goes without saying that the bit numbers (8 bits, 4 bits) are only by way of example.

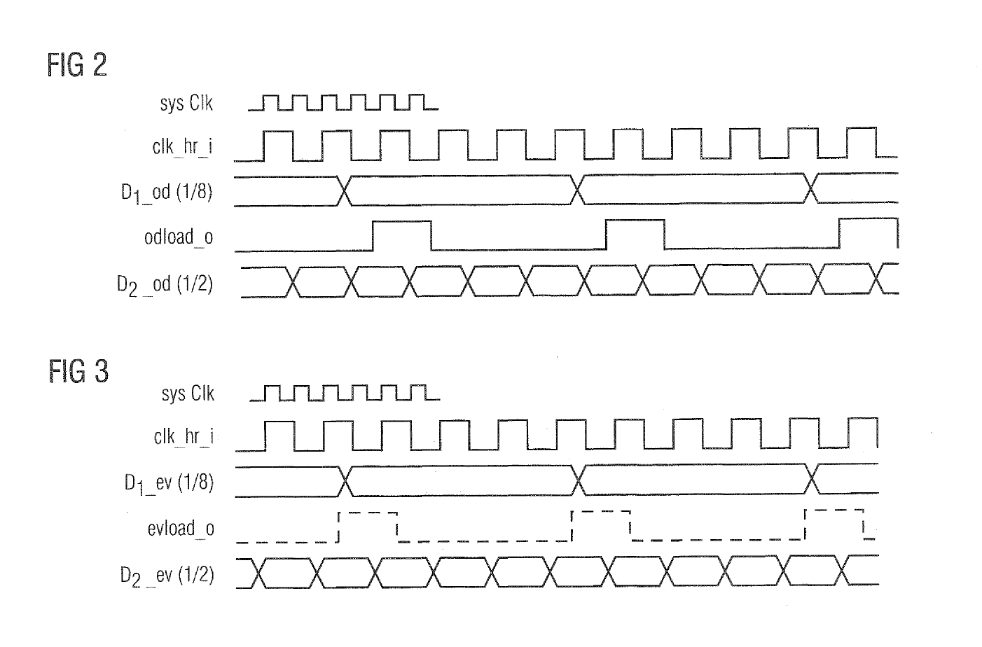

The function just described of the synchronous parallel-serial converter 1 illustrated in FIG. 1 is graphically illustrated in the pulse timing diagrams in FIGS. 2 to 4.

In order to ensure, at the high clock frequencies (for the half-rate clock clk_hr_i e.g. 2 GHz), a stable data acceptance into the first and second shift register SR_od and SR_ev in each case by means of the load signal odload_o and evload_o with at the same time a minimal latency in the synchronous parallel-serial converter, the two load signals odload_o and evload_o are required to be generated in a manner synchronous with the half-rate clock signal clk_hr_i and in a manner that can be adjusted temporally by way of the time duration between two data changes.

Therefore, it is an object of this invention to enable a controller of the type mentioned in the introduction which can meet the above requirement and generate the control signals necessary for the synchronous parallel-serial conversion of the data signals outlined above.

This object is achieved as claimed.

In accordance with one basic aspect, a controller according to the invention, which controller achieves the above object, for generating control signals synchronous with a continuous clock signal input to it for a device to be controlled synchronously with the clock signal, is characterized by the fact that the controller has: register means for registering at least one set signal, comprising a plurality of bit positions, counting means for counting edges of the clock signal depending on one or a plurality of set signals respectively registered in the register means, and synchronization and output means for synchronizing a value counted by the counting means with the clock signal and the registered set signal and outputting at least one of the control signals, wherein the register means, the counting means and the synchronization and output means are configured and connected to one another in such a way that the output control signal(s), depending on the respectively registered set signal, occupies (occupy) one of a plurality of temporal positions with a respective phase difference of an integral multiple of half a clock cycle synchronously with the leading or trailing edge of the clock signal.

In accordance with a preferred first exemplary embodiment, the controller according to the invention is characterized by the fact that the register means are set up for registering at least one first set signal comprising n (n≧2) bit positions, the counting means are triggered by the leading (trailing) edge of the clock signal and/or by the trailing (leading) edge of the clock signal, and are set by the respective value of at least the first set signal registered in the register means in such a way that the synchronization and output means output a first control signal with a first control signal component and a second control signal component, which has a fixed phase difference of half a clock cycle with respect to the first control signal component, and both control signal components with a periodicity of an integral multiple of the clock cycle and the duty ratio 1:4 in such a way that they can together occupy at least n² different temporal positions synchronously with the clock signal. In the case of this exemplary embodiment, n may be equal to 2, the periodicity of the first control signal may be four clock cycles and the phase difference between four successive temporally different position steps thereof may be in each case one clock cycle.

In accordance with a preferred second exemplary embodiment, the controller according to the invention is characterized by the fact that n=3, the periodicity of the first control signal is four clock cycles and the phase difference between its eight temporally different positions is in each case half a clock cycle, and the synchronization and output means are additionally set up for generating and outputting a static control signal which, depending on a registered value of the first set signal, specifies an item of information as to whether the device that is to be controlled by the controller and for this purpose receives the static control signal and the first and second control signal components of the first control signal is to be synchronized with the leading or trailing edge of the clock signal.

Even more preferred is a controller according to the invention which is characterized by the fact that the register means are set up for registering a second set signal comprising two bit positions, n=2 and the periodicity of the first control signal is four clock cycles, wherein, depending on the registered first and second set signals, the counting means are set in such a way that the synchronization and output means output a second control signal with a periodicity of four clock cycles, the duty ratio 1:2 and in three positions that differ temporally in each case by one clock cycle, and the first control signal in such a way that the phase difference between four successive position steps thereof is respectively one, one, two, and two clock signal periods.

Even more preferred is a fourth exemplary embodiment of the controller according to the invention, which embodiment is characterized by the fact that the register means are set up for registering a second set signal comprising three bit positions, n=3 and the periodicity of the first control signal is four clock cycles, wherein, depending on the registered first and second set signals, the counting means are set in such a way that the synchronization and output means output a second control signal with a periodicity of four clock cycles, the duty ratio 1:2 and in three positions that differ temporally in each case by half a clock cycle.

A controller corresponding to a fifth exemplary embodiment is characterized according to the invention by the fact that the register means are set up for registering a second set signal comprising two bit positions, n=2 and the periodicity of the first control signal is four clock cycles, and the controller additionally receives a continuous write signal, which is derived from the clock signal and is synchronous with the latter, with a periodicity of four clock cycles and also an asynchronous reset signal wherein the counting means, depending on the registered first and second set signals, are set in such a way that the synchronization and output means output the first control signal in such a way that the phase difference between four temporally different positions thereof is in each case one clock period and a second control signal with a periodicity of four clock cycles, the duty ratio 1:2 and in four positions that differ temporally in each case by one clock period, and delayed by a respectively determined number of clock cycles with respect to the write signal, and also a reset signal synchronized with the clock signal, in such a way that its trailing (leading) edge coincides temporally with the asynchronous reset signal and its leading (trailing) edge lies at least half a clock period before the leading edge of the second control signal.

In accordance with a sixth exemplary embodiment, a controller according to the invention is characterized by the fact that the register means are set up for registering a second set signal comprising three bit positions, the bit number of the first set signal is n=3 and the periodicity of the first control signal is four clock cycles and the phase difference between the eight different time positions of the first control signal is in each case half a clock cycle, and the controller additionally receives a continuous write signal, which is derived from the clock signal and is synchronous with the latter, with a periodicity of four clock cycles and also an asynchronous reset signal, wherein the counting means, depending on the registered first and second set signals, are set in such a way that the synchronization and output means output a second control signal with a periodicity of four clock cycles, the duty ratio 1:2 and relative to the phase of the write signal in eight different time positions that differ by in each case half a clock cycle, a reset signal which is synchronized with the clock signal and whose trailing (leading) edge coincides temporally with the asynchronous reset signal and whose leading (trailing) edge lies at least half a clock period before the leading edge of the second control signal, and also a static control signal, which, depending on a registered value of the first set signal, specifies an item of information as to whether the device that is to be controlled by the controller and for this purpose receives the static control signal and the first and second control signals is to be synchronized with the leading or trailing edge of the clock signal.

In the various exemplary embodiments according to the invention, the register means register the set signal(s) synchronously with the clock signal, to be precise expediently once during the starting up of the entire device.

A controller according to the invention which corresponds to one of the exemplary embodiments above is preferably used for controlling a synchronous parallel-serial converter which has been described in the introduction with reference to FIGS. 1 to 4 and which converts a parallel input signal into a serial 1-bit output signal sequence synchronously with the clock signal.

As a result, a controller suitable particularly for the synchronous control of a parallel-serial converter provided in a transmitting section of an interface circuit of a DDR DRAM semiconductor memory component of the coming memory generation for the parallel-serial conversion of data signals generates, according to the invention, control signals synchronous with a continuous clock signal input to it and has: register means for registering at least one set signal, comprising a plurality of bit positions, counting means for counting edges of the clock signal depending on one or a plurality of set signal(s) respectively registered in the register means, and synchronization and output means for synchronizing a value counted by the counting means with the clock signal and the registered set signal and outputting at least one of the control signals, wherein the register means, the counting means and the synchronization and output means are configured and connected to one another in such a way that the output control signal(s), depending on the respectively registered set signal, occupies (occupy) one of a plurality of temporal positions with a respective phase difference of an integral multiple of half a clock cycle synchronously with the leading or trailing edge of the clock signal. The particular advantages of this controller are that the clock-synchronous control signals which it generates can be generated in selectable/programmable fashion by means of the respectively registered set signals at one of a plurality of temporal positions within a given time period, to be precise synchronously with the leading or trailing edge of the clock signal.

The above and further advantageous features of a controller according to the invention are explained in more detail in the following description of a plurality of exemplary embodiments relating to the preferred application of the controller in a synchronous parallel-serial converter, with reference to the drawing. In the figures of the drawing, specifically:

FIG. 1 shows the function block circuit diagram—already explained in the introduction—of a basic form of a synchronous parallel-serial converter;

FIGS. 2-4 show signal timing diagrams for elucidating the function of the synchronous parallel-serial converter illustrated in FIG. 1 (already explained in the introduction);

FIG. 5 shows a function block diagram of a first exemplary embodiment of a controller according to the invention;

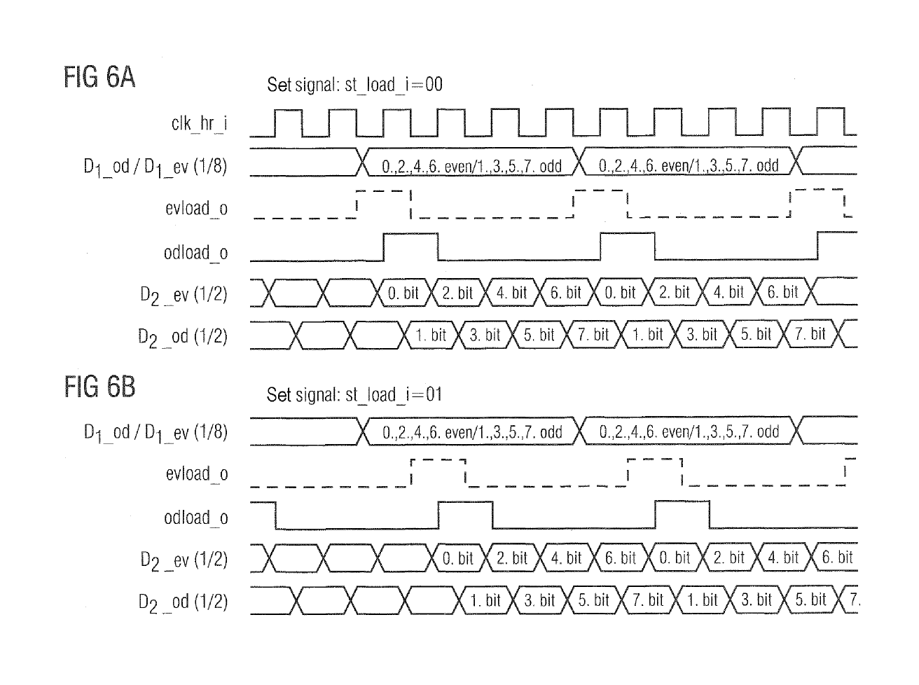

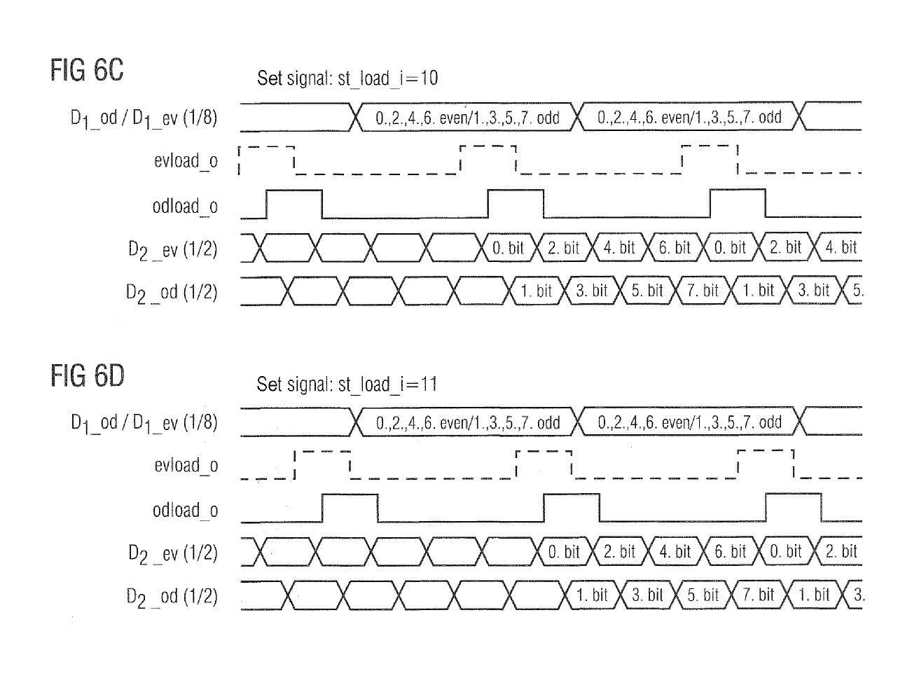

FIGS. 6A-6D show signal timing diagrams for elucidating the functioning of the first exemplary embodiment of the controller according to the invention;

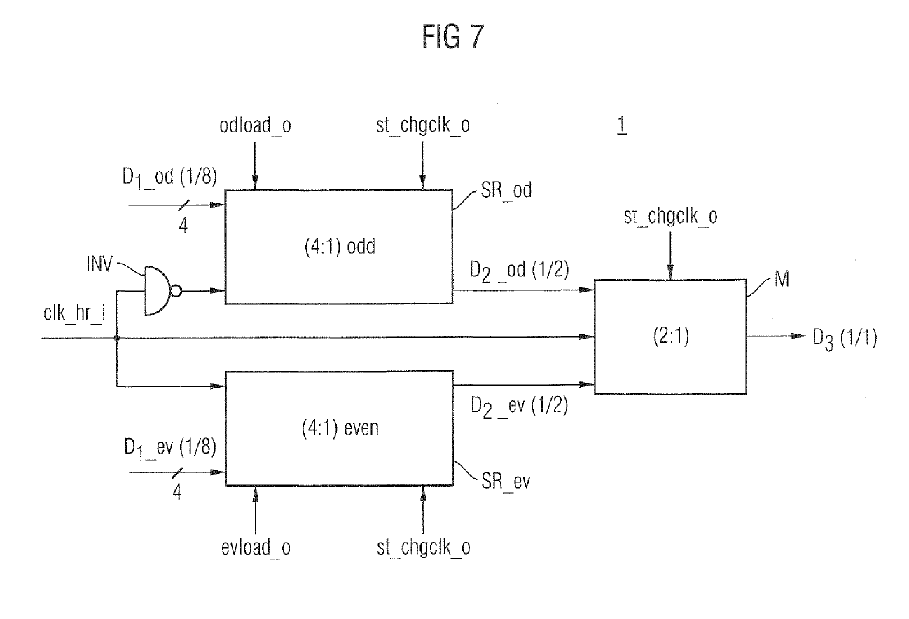

FIG. 7 shows a function block diagram of a synchronous parallel-serial converter that is functionally extended by comparison with the one shown in FIG. 1;

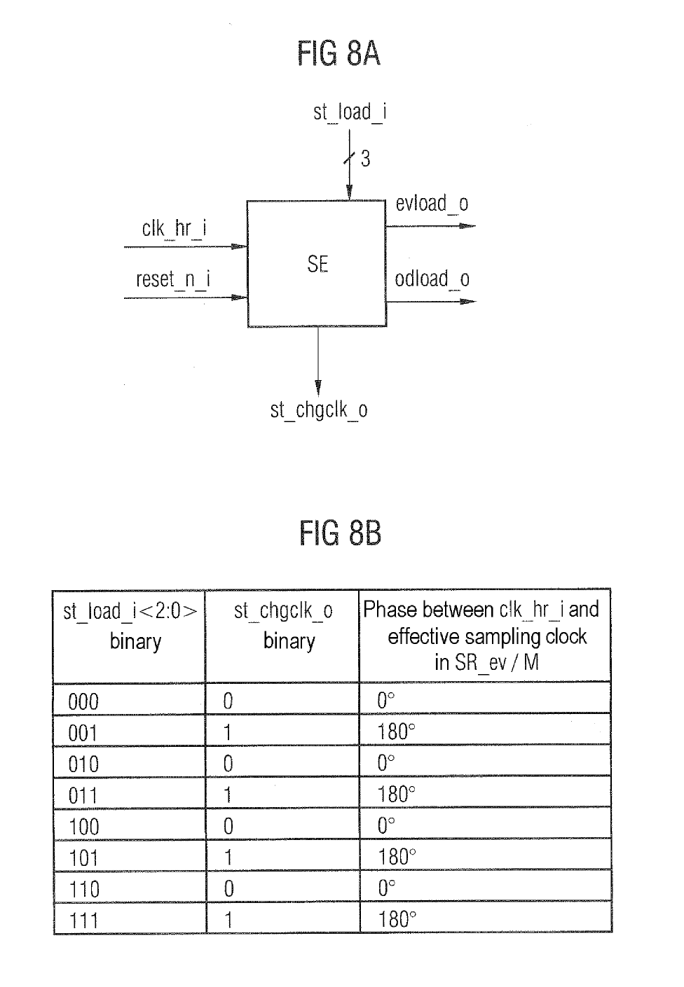

FIG. 8A shows a function block diagram of a second exemplary embodiment of a controller according to the invention, which can be used in the synchronous parallel-serial converter shown in FIG. 7;

FIG. 8B shows in tabular form a control signal resulting from a first set signal present at the controller illustrated in FIG. 8A, and the effect of said control signal on the phase between the clock signal and the effective sampling clock in one of the shift registers of the synchronous parallel-serial converter illustrated in FIG. 7;

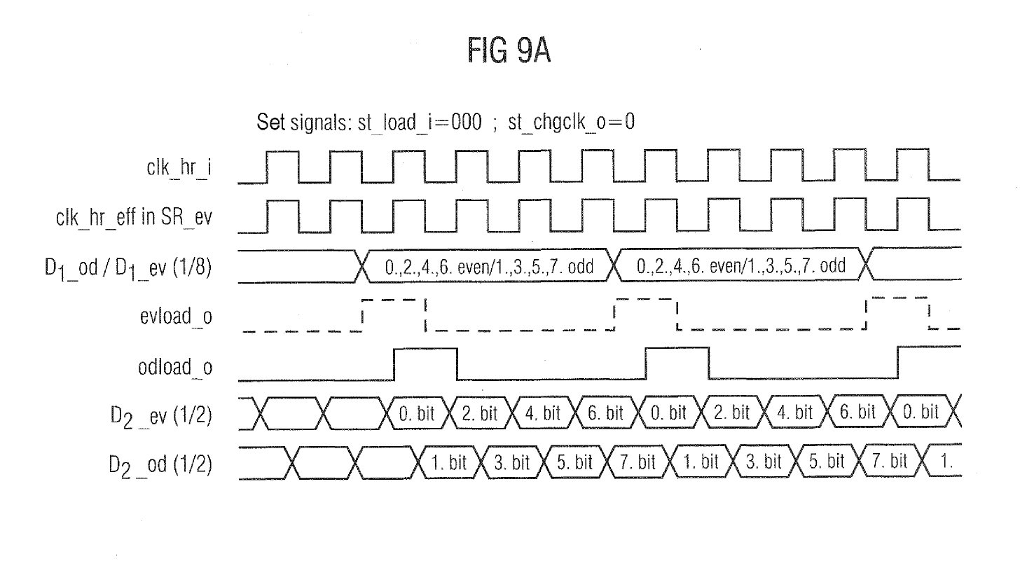

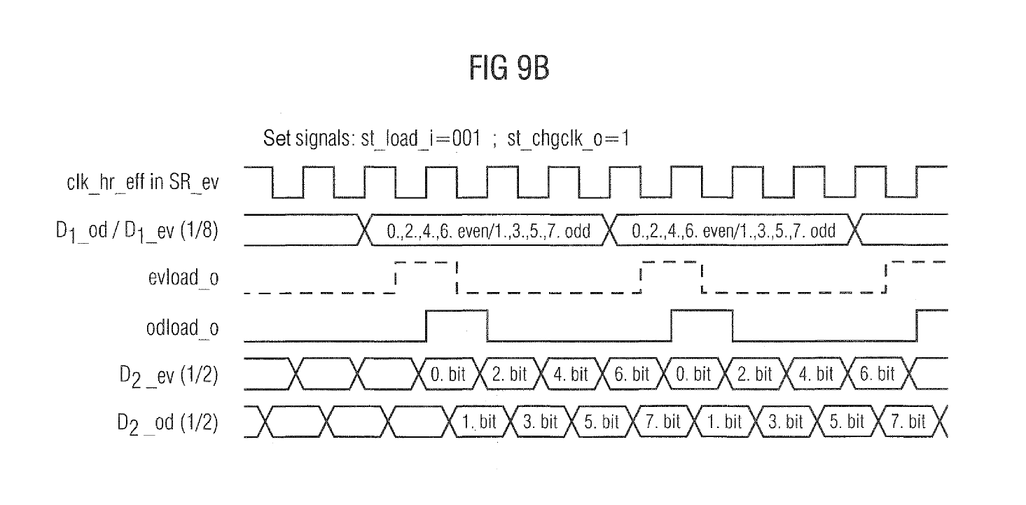

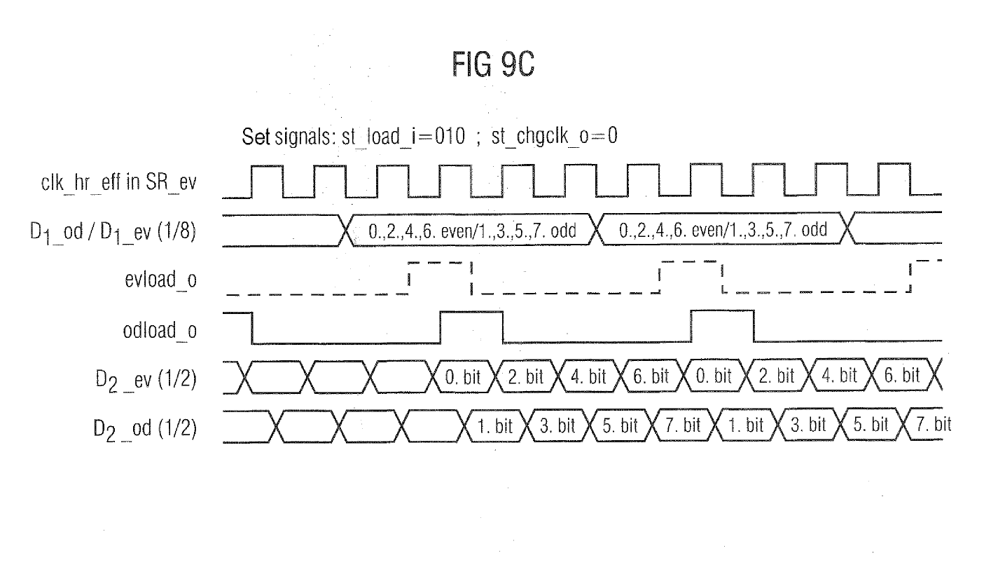

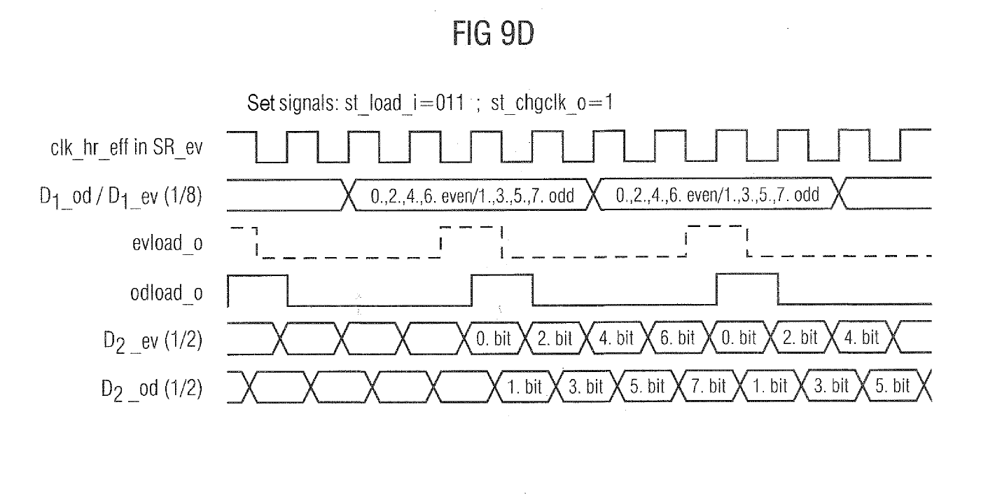

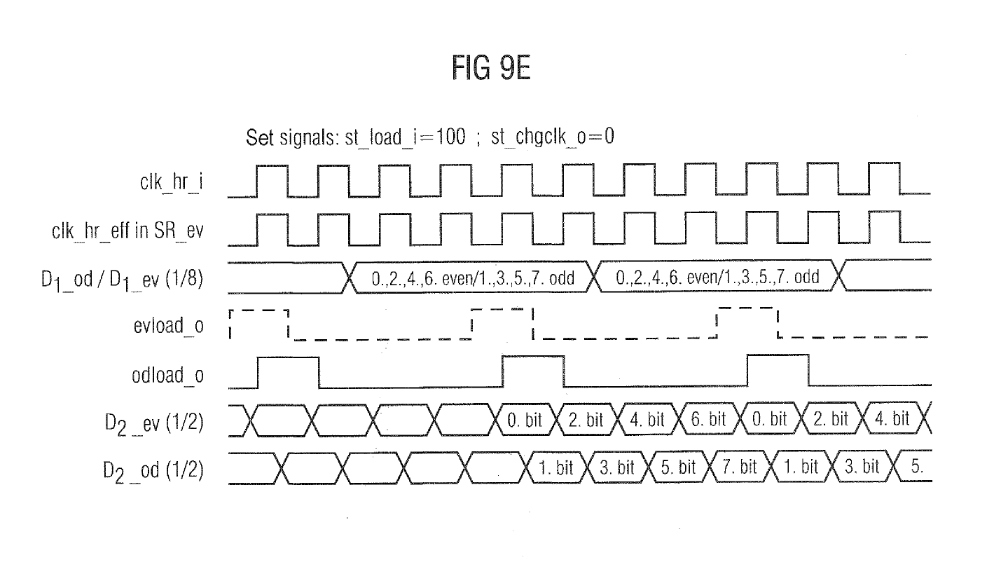

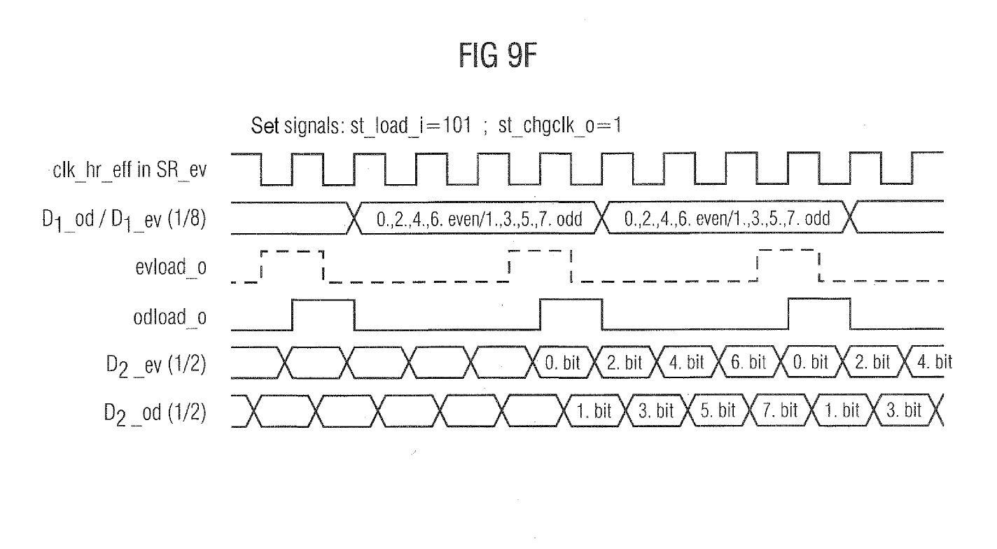

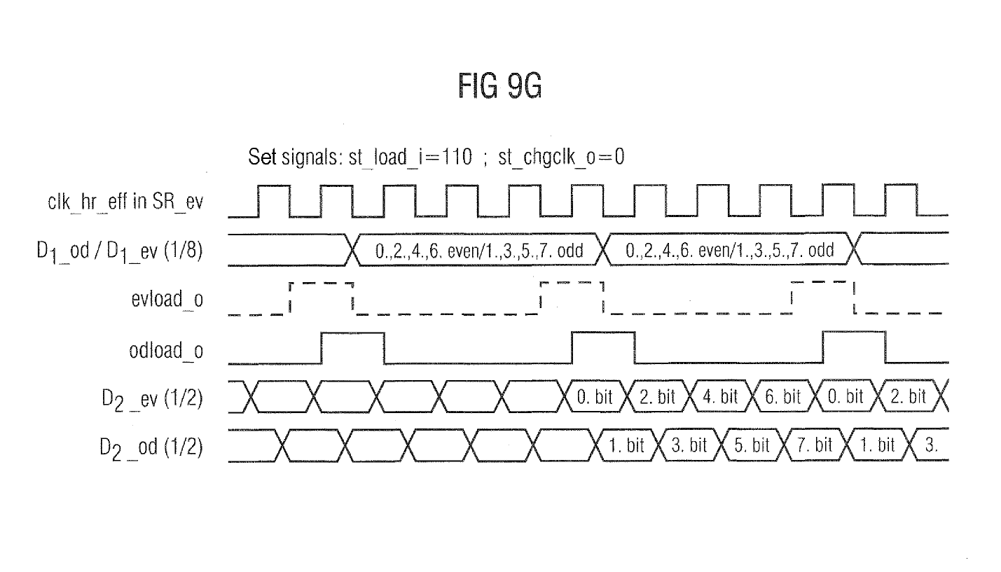

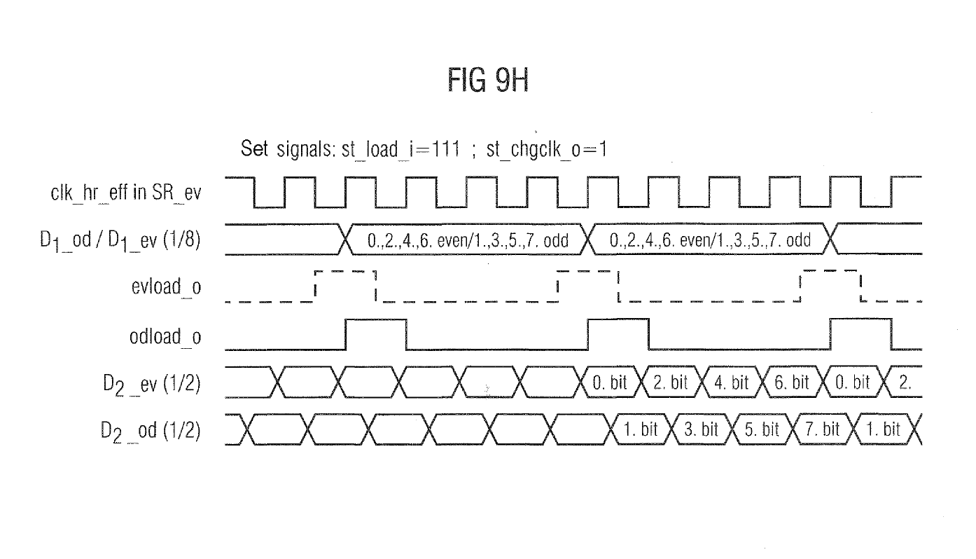

FIGS. 9A-9H show signal timing diagrams for elucidating the function of the controller illustrated in FIG. 8A and the synchronous parallel-serial converter illustrated in FIG. 7;

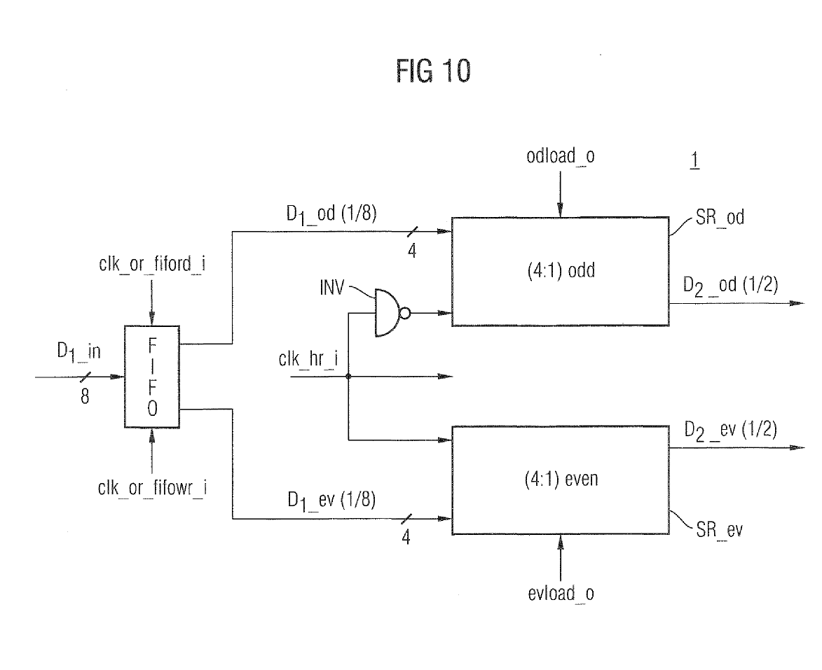

FIG. 10 shows a function block diagram of a synchronous parallel-serial converter that is functionally extended by comparison with the one illustrated in FIG. 1;

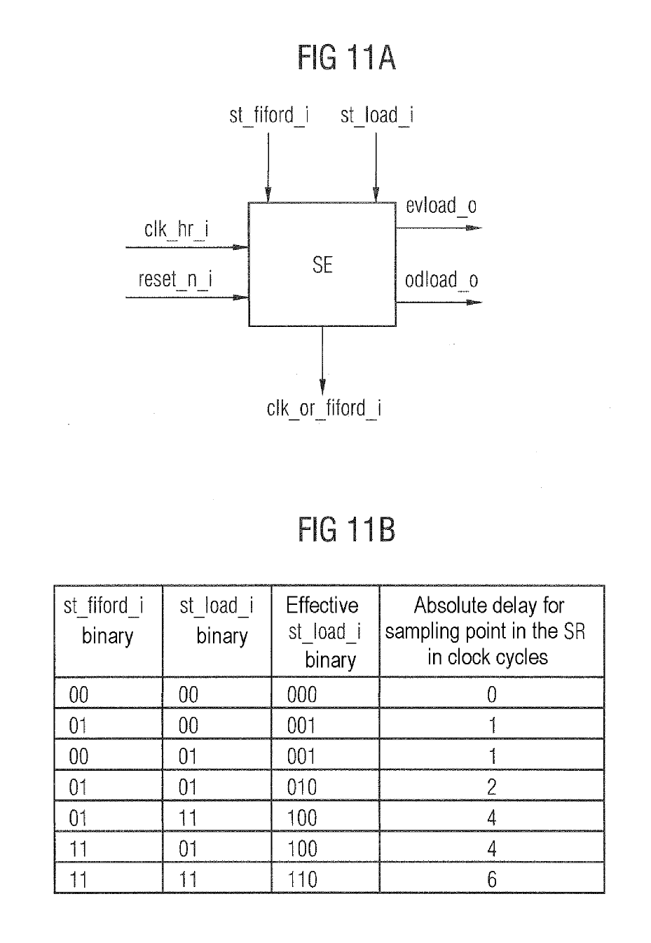

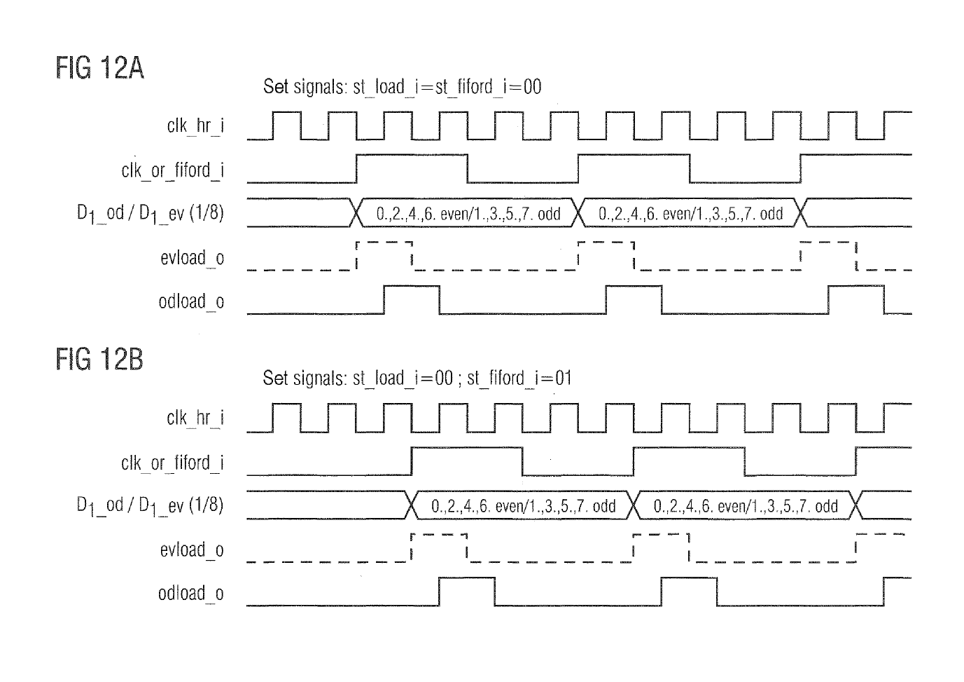

FIG. 11A shows a function block diagram of a third exemplary embodiment of a controller according to the invention which can be used for controlling the synchronous parallel-serial converter illustrated in FIG. 10;

FIG. 11B shows in tabular form the result of the synchronization of a first set signal with a second set signal;

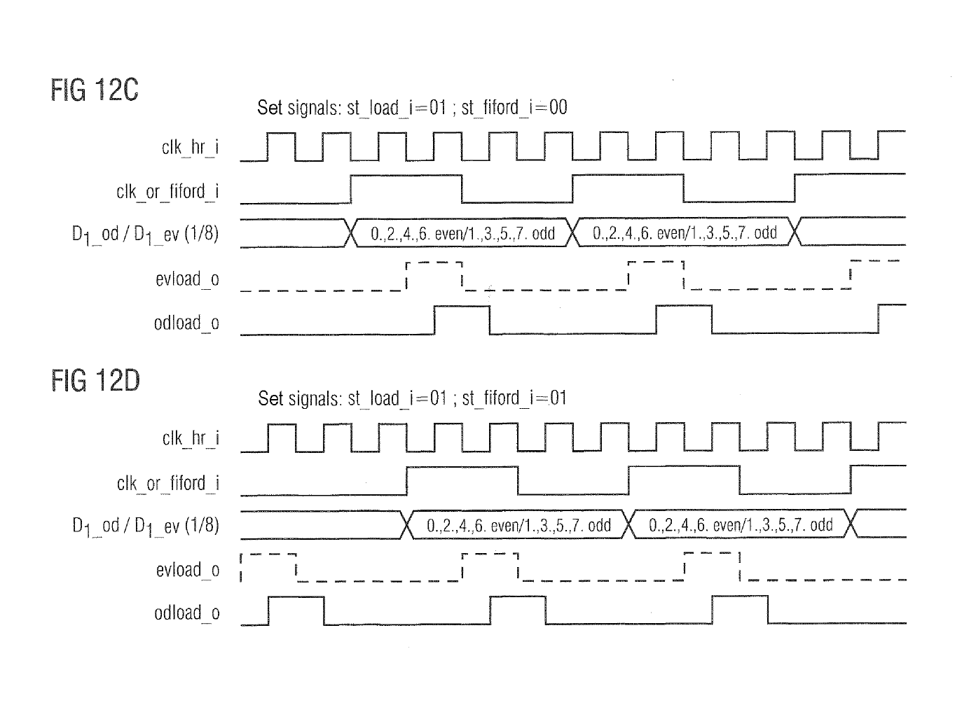

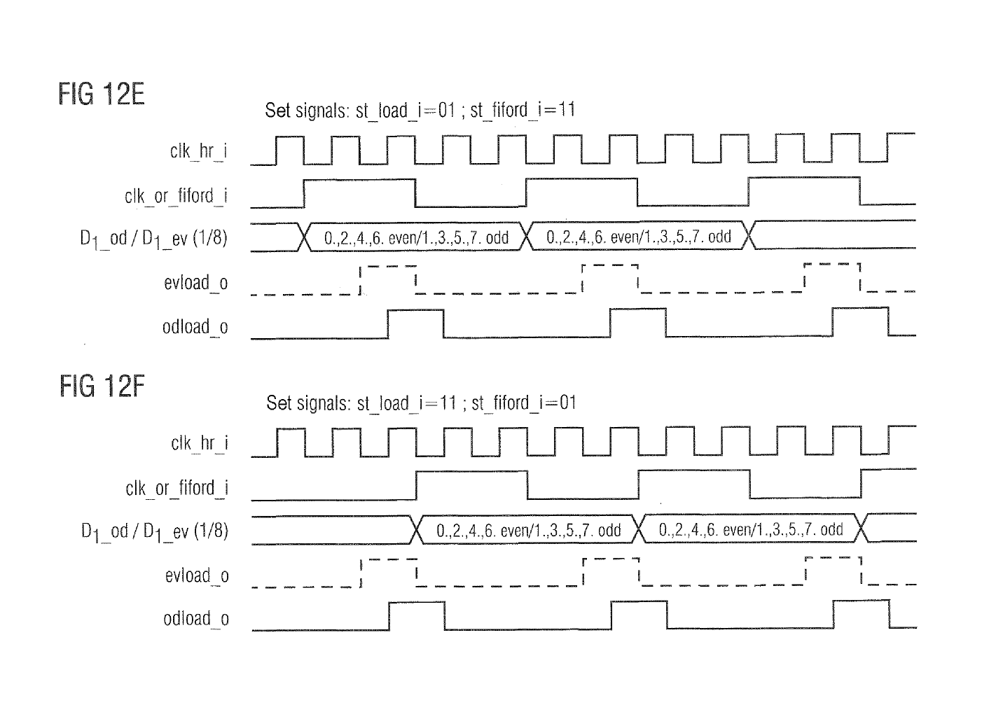

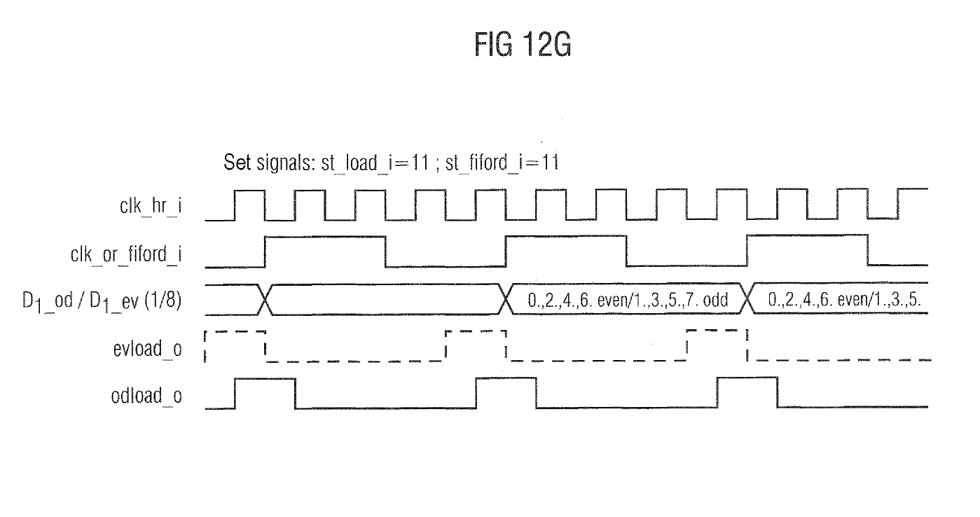

FIGS. 12A-12G show signal timing diagrams for elucidating the function of the controller illustrated in FIG. 11A;

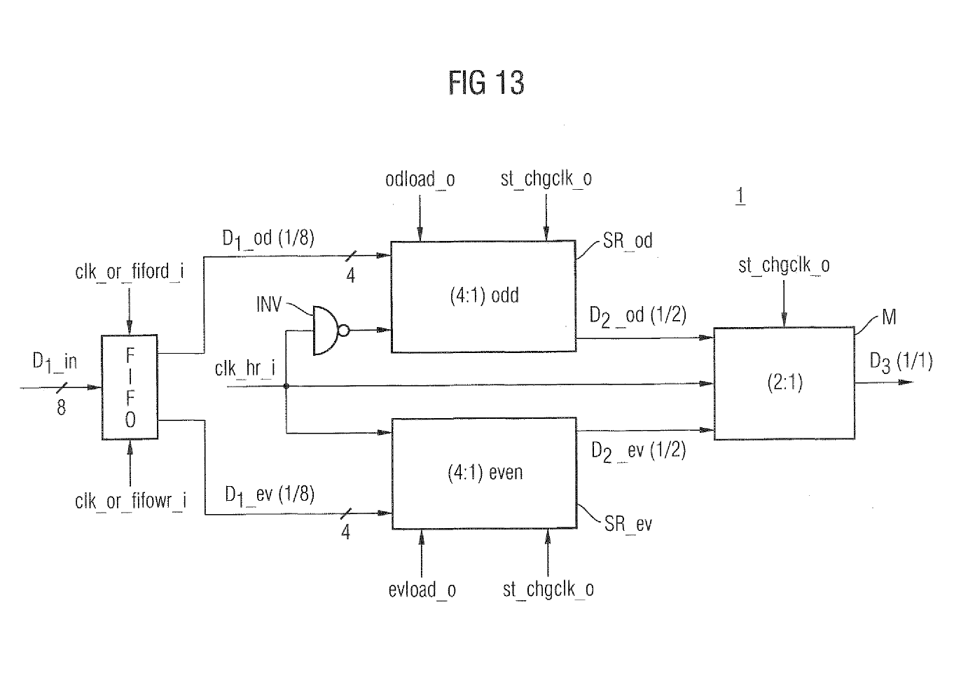

FIG. 13 shows a function block diagram of a synchronous parallel-serial converter that is functionally extended by comparison with the one illustrated in FIG. 1;

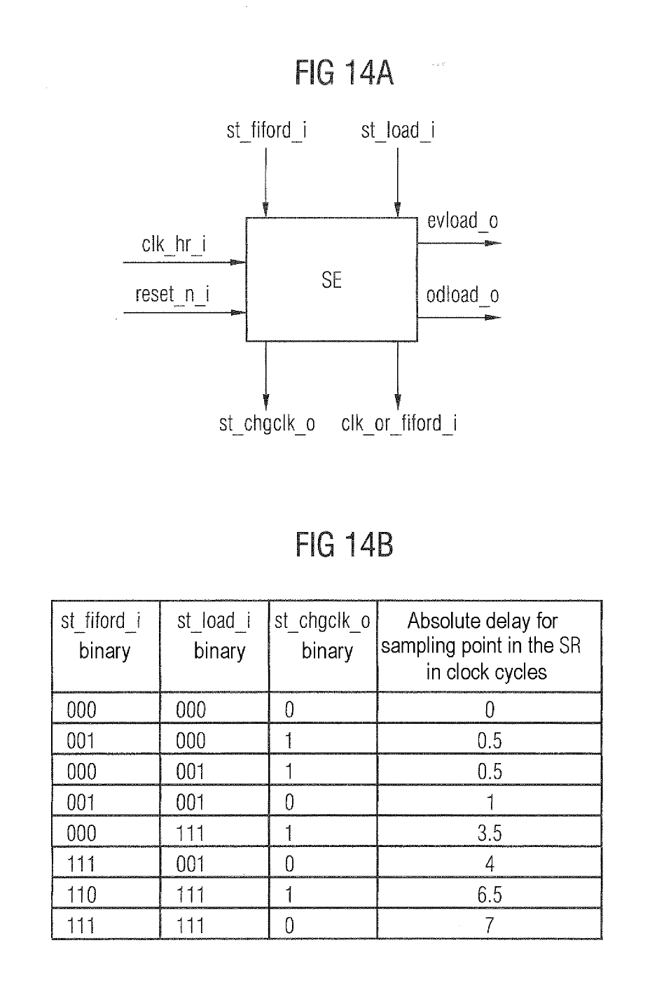

FIG. 14A shows a function block diagram of a fourth exemplary embodiment of a controller for generating control signals in particular for controlling the synchronous parallel-serial converter illustrated in FIG. 13;

FIG. 14B shows in tabular form the result of the synchronization of a first and second binary control signal by means of the controller shown in FIG. 14A;

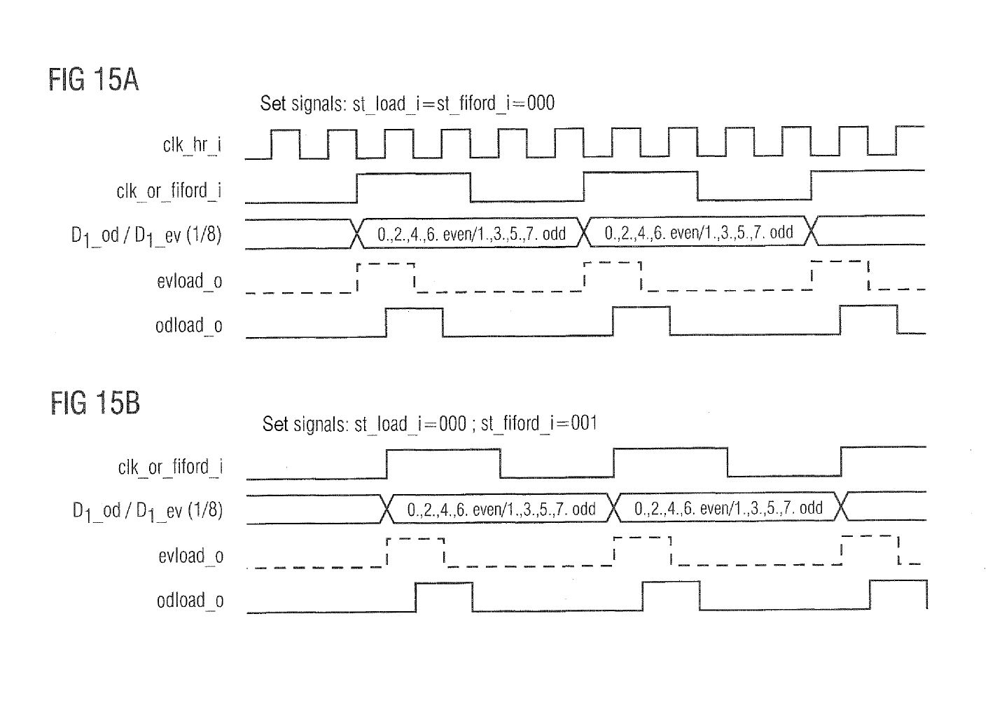

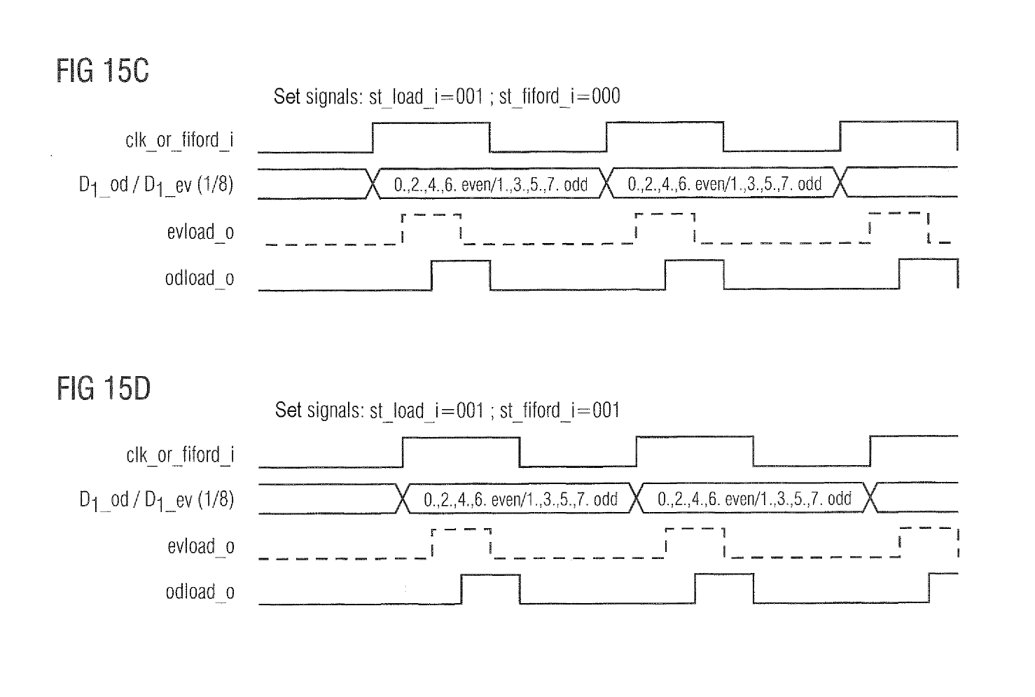

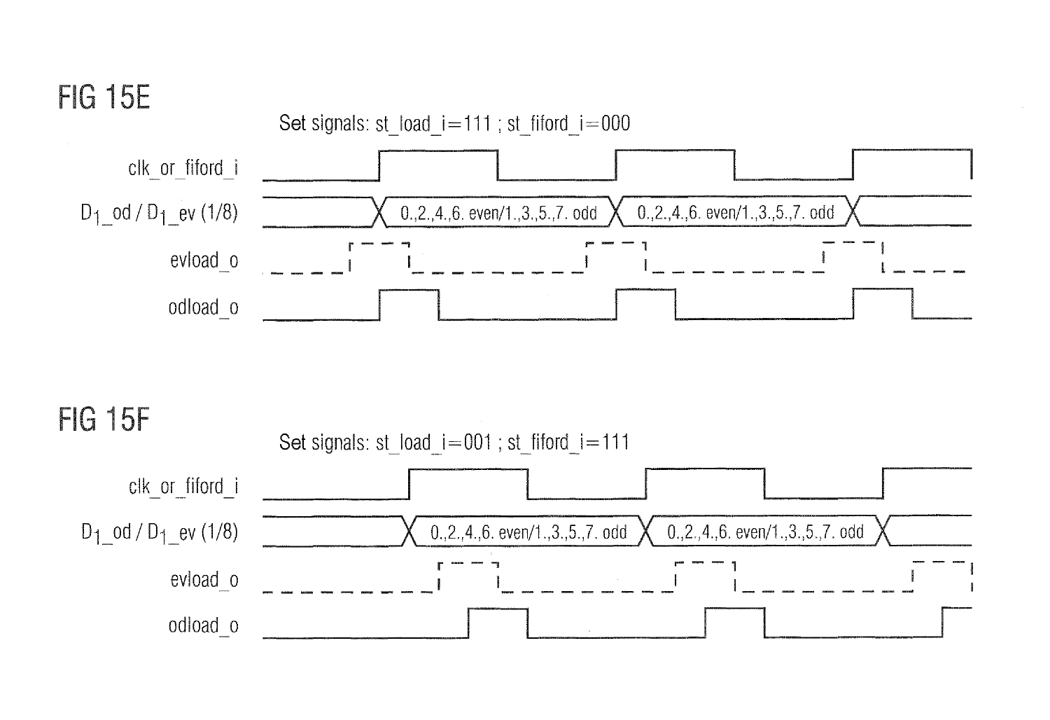

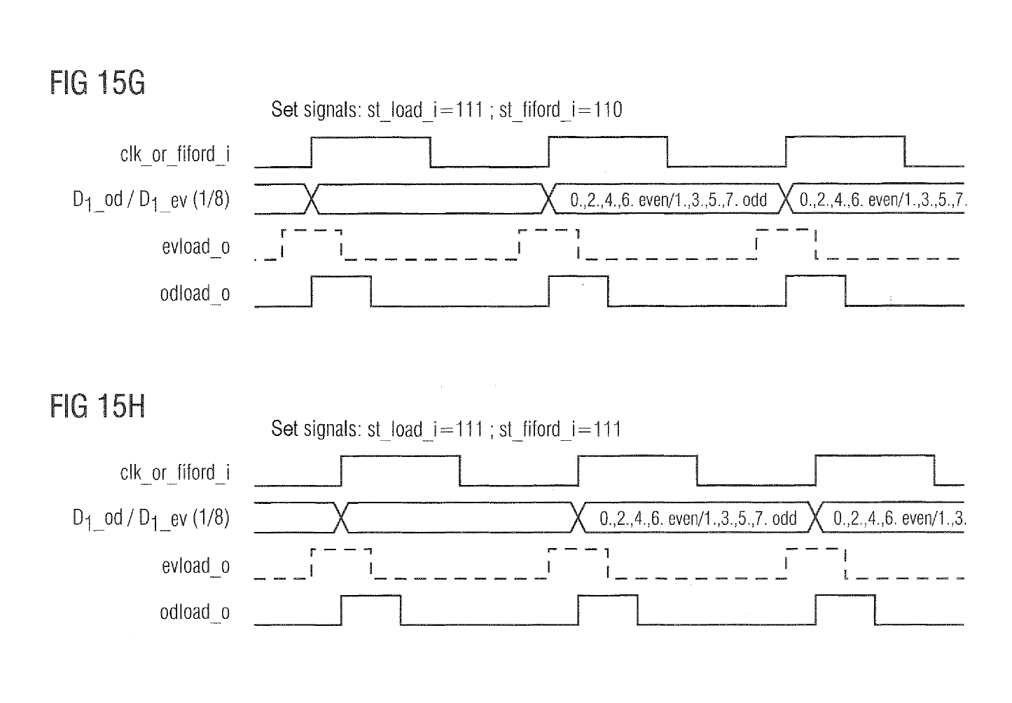

FIGS. 15A-15H show signal timing diagrams for elucidating the function of the controller illustrated in FIG. 14A and the synchronous parallel-serial converter illustrated in FIG. 13;

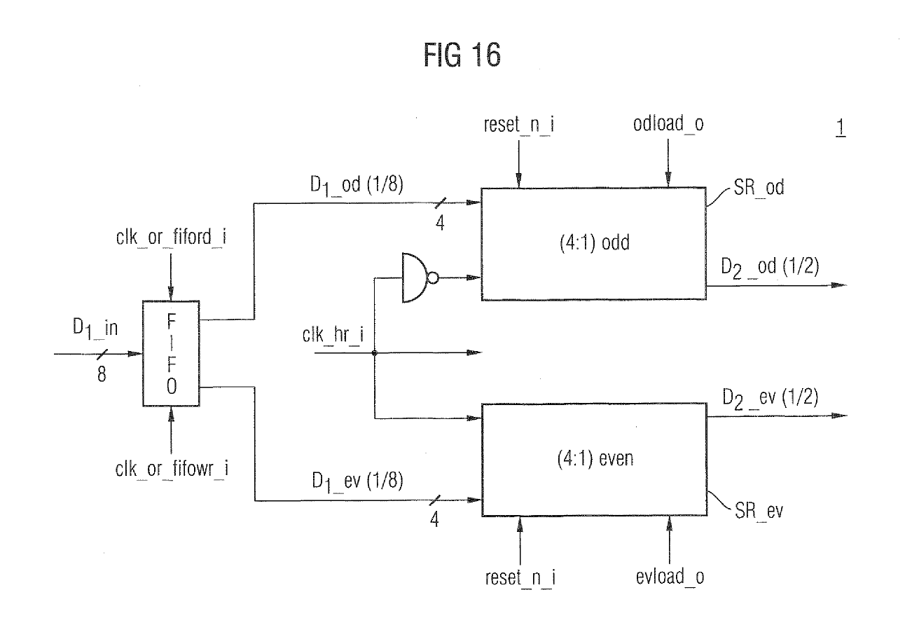

FIG. 16 shows a further synchronous parallel-serial converter having an extended function by comparison with the one shown in FIG. 1;

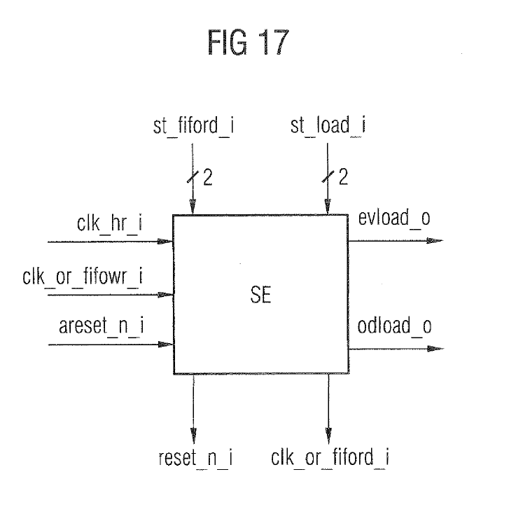

FIG. 17 shows a function block diagram of a fifth exemplary embodiment of a controller according to the invention which generates control signals in particular for application in the synchronous parallel-serial converter illustrated in FIG. 16;

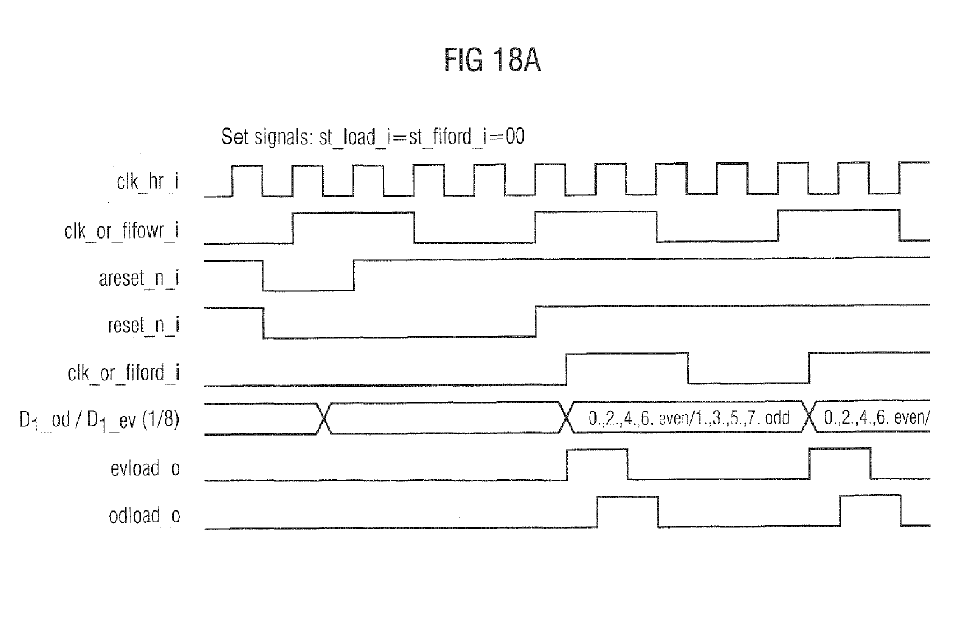

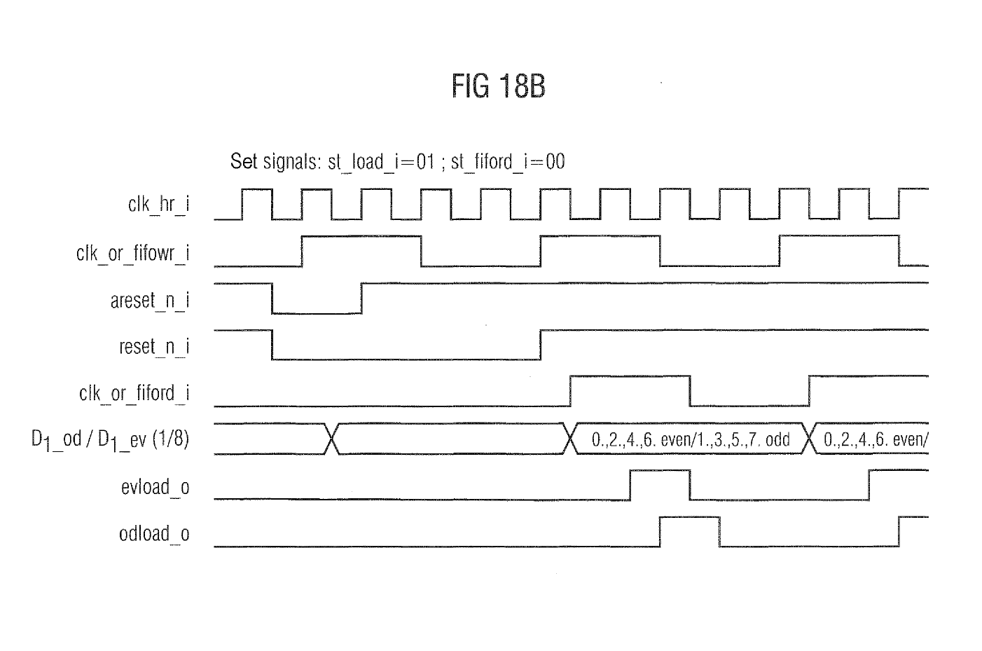

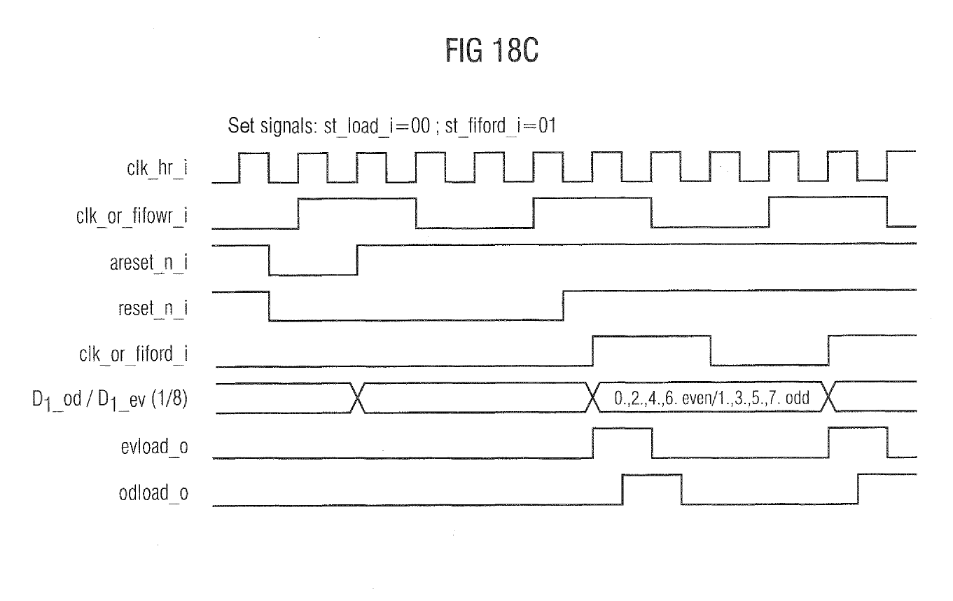

FIGS. 18A-18C show signal timing diagrams for elucidating the function of the controller illustrated in FIG. 17 and the synchronous parallel-serial converter illustrated in FIG. 16;

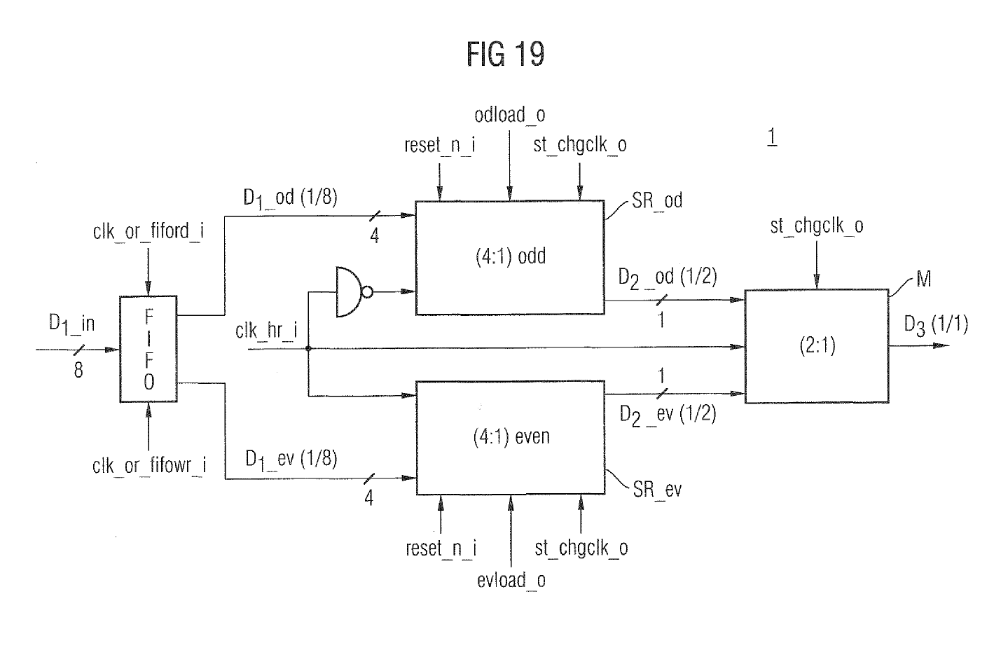

FIG. 19 shows a function block diagram of a synchronous parallel-serial converter having an extended function by comparison with the one shown in FIG. 1;

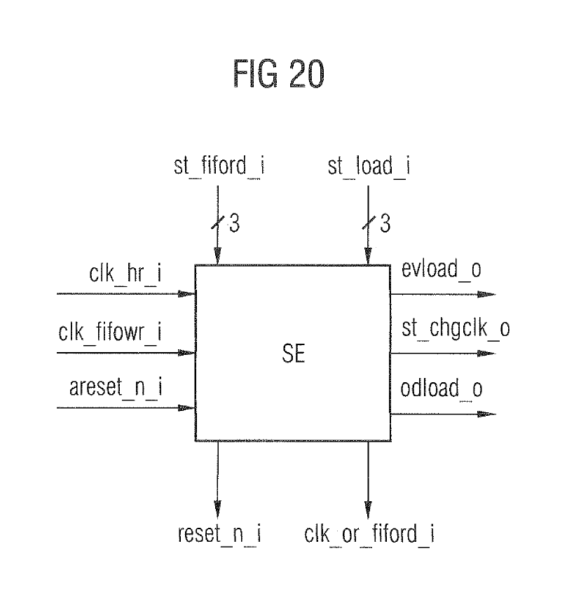

FIG. 20 shows a function block diagram of a sixth exemplary embodiment of a controller according to the invention for generating control signals which can be applied in particular for controlling the synchronous parallel-serial converter shown in FIG. 19, and

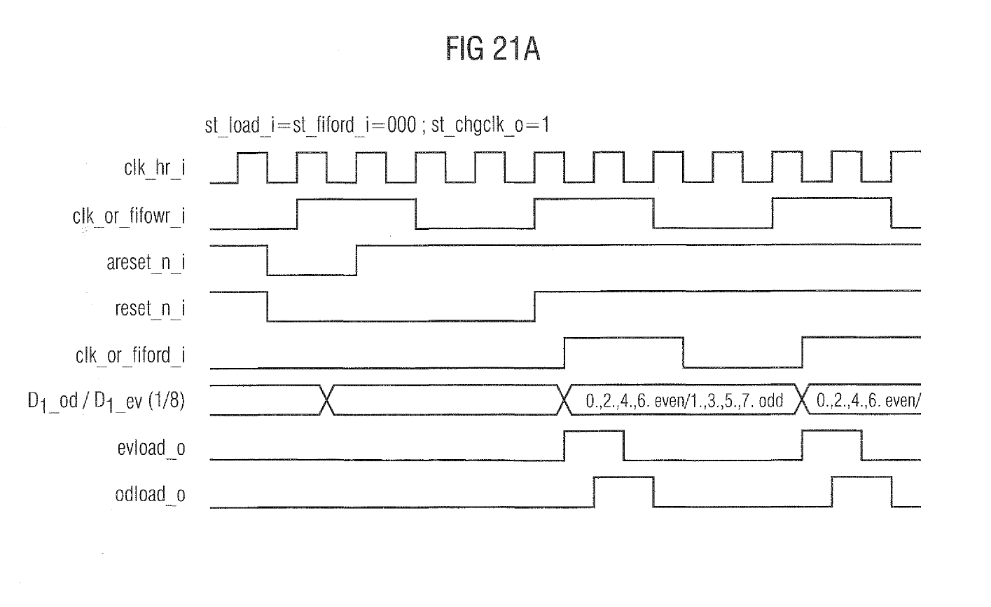

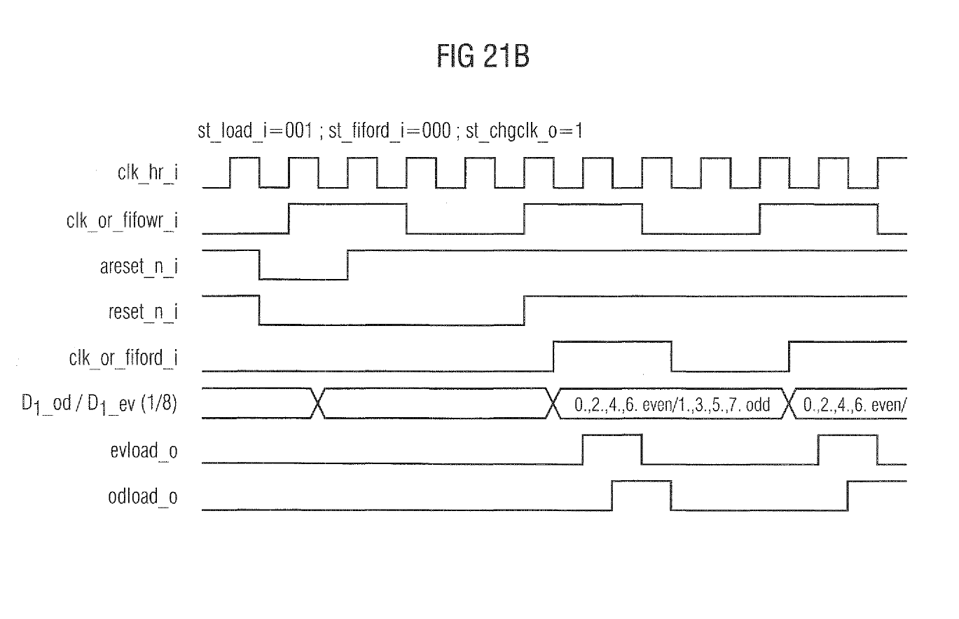

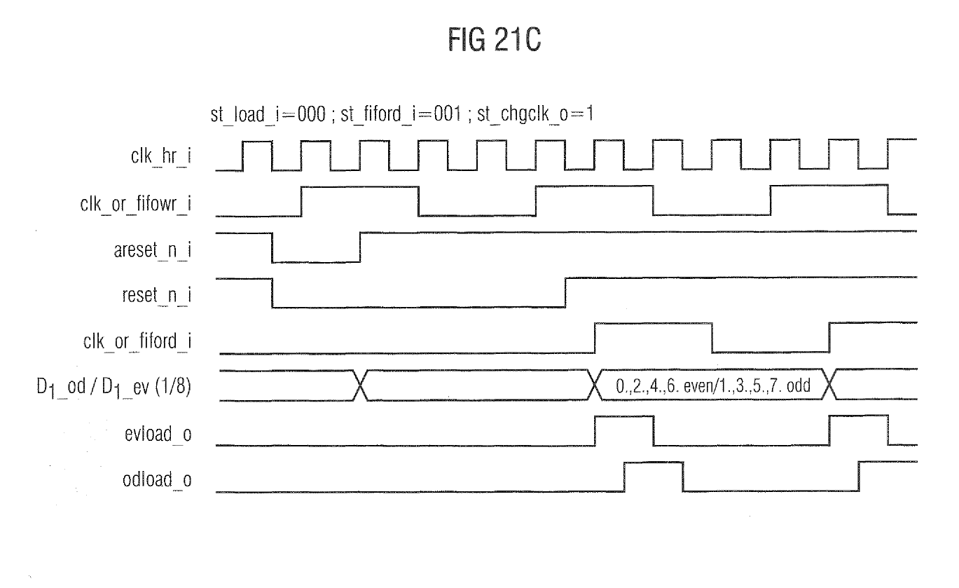

FIGS. 21A-21C show signal timing diagrams for elucidating the function of the controller illustrated in FIG. 20 and the synchronous parallel-serial converter illustrated in FIG. 19.

A description is given below of a plurality of preferred exemplary embodiments of a controller according to the invention together with their respective application for generating control signals for a synchronous parallel-serial converter whose basic features have already been explained with reference to FIGS. 1 to 4. As already mentioned there, load or sampling signals odload_o and evload_o are respectively fed to the first shift register SR_od and the second shift register SR_ev. It has also already been mentioned that for a compromise between the latency of the data bits and their reliable acceptance into the shift registers, it is necessary that the temporal position of the sampling signals odload_o, evload_o can be set in selectable fashion in a specific time frame. This task is fulfilled by the first exemplary embodiment—illustrated in FIG. 5—of a controller SE according to the invention. The controller SE receives the clock signal clk_hr_i in accordance with FIG. 5. The signal contraction hr denotes half rate, that is to say that this clock signal refers to a basic or system clock oscillating at double frequency. It should be noted that the basic or system clock (sys_clk) does not have to be transmitted between the individual components of the system. Furthermore, the controller SE in FIG. 5 receives a reset signal reset_n_i, the function of which is explained later. Furthermore, a set signal (first set signal) st_load_i, here in the form of a two-bit signal, is fed to the controller SE. The controller SE has (not shown) register means for registering the set signal, counting means for counting edges of the clock signal depending on the set signal registered in the register means, and also synchronization and output means for synchronizing a value counted by the counting means with the clock signal clk_hr_i and the registered set signal st_load_i and for outputting a first control signal evload_o and odload_o containing two components. The register means, counting means and synchronization and output means (not shown) are set up and connected to one another in the controller SE in such a way that the first control signal output by the controller, depending on the registered set signal st_load_i, occupies one of a plurality of temporal positions with a respective phase difference of an integral multiple of half a clock cycle synchronously with the leading or trailing edge of the clock signal.

In the case of the first exemplary embodiment of the controller according to the invention as illustrated in FIG. 5, the first control signal evload_o, odload_o generated by the controller contains a first and second control signal component, which have a fixed phase difference with respect to one another and which are output via two mutually separate control signal lines. On account of the set signal st_load_i comprising two bit positions, the two control signal components evload_o and odload_o of the first control signal can occupy four temporal positions synchronously with the clock signal clk_hr_i which are different from one another in each case by one clock signal period (clock cycle). The two control signal components evload_o and odload_o have an invariable phase difference of half a clock cycle with respect to one another. Consequently, the first control signal component evload_o and the second control signal component odload_o, in conjunction with the inverter element INV depicted by dashed lines in FIG. 1, have the effect that the first and second shift registers SR_od and SR_ev of the parallel-serial converter 1 accept the four data bits D1_od and D1_ev present at it in each case with the same (e.g. leading edge) edge of the clock signal clk_hr i and from the inverted signal thereof. This has the advantage that the circuit design of the two shift registers SR_od and SR_ev can be identical. It should be mentioned that the set signal st_load_i can be registered in the register means of the controller SE synchronously with the clock signal clk_hr_i.

The signal timing diagrams shown in FIGS. 6A-6D show the four possible temporal positions—shifted relative to one another in each case by one clock cycle—of the two control signal components evload_o and odload_o of the first control signal depending on the respective binary value of the first set signal st_load_i. In this way, through the choice of the phase angle of the first and second control signal components evload_o and odload_o, it is possible to achieve a compromise between reliable data acceptance and a shortest possible latency of the data bits in the two shift registers SR_od and SR_ev of the synchronous parallel-serial converter in accordance with FIG. 1. The ability to select a best possible compromise between reliable data acceptance and a shortest possible latency is very important given the extremely high transmission rates or clock frequencies of future DDR DRAM generations (DDR4 et seq.). It should be noted here that the inverter element INV is dispensable if the clock signal clk_hr_i is fed as a differential signal, such that the first shift register sr_od receives the inverted component of the differential clock signal and the second shift register receives the noninverted component thereof.

The function block diagram illustrated in FIG. 7 shows a synchronous parallel-serial converter that is functionally extended by comparison with the one in FIG. 1. The first and second shift registers SR_od and SR_ev and also the merging unit M receive an additional static control signal st_chgclk_o, which specifies an item of information about whether the leading or trailing edge of the clock signal is to be used for the acceptance of the data bits in the first and second shift registers and for the acceptance of the serial half-rate data streams d2_od and d2_ev respectively output by the two shift registers SR_od and SR_ev in the merging unit M.

The second exemplary embodiment of the controller according to the invention, which embodiment is illustrated as a function block diagram in FIG. 8A, generates, in addition to the first and second control signal components evload_o and odload_o of the first control signal that are used for data sampling or acceptance in the second and first shift registers SR_ev and SR_od, the second control signal st_chgclk_o, which has the function mentioned above, to be precise depending on the clock signal clk_hr_i present and the first set signal st_load_i registered in the register means of the controller SE, said set signal being fed and registered as a three-bit signal in this exemplary embodiment.

FIG. 8B shows in tabular form the binary value of the second control signal st_chgclk_o and the resultant phase difference in each case between the clock signal clk_hr i and the effective sampling clock in the second shift register SR_ev and in the merging unit M.

The signal timing diagrams in FIGS. 9A-9H show that the eight temporal positions (phase angles) of the first and second control signal components evload_o and odload_o of the first control signal, which are generated with a fixed phase difference of half a clock cycle with respect to one another, differ in each case by half a clock cycle (half a clock period). The result is that the abovementioned compromise between reliable data acceptance in the shift registers and latency of the data bits therein can be set in temporally even smaller increments (e.g. in temporal increments of 1 ns). Since, in this exemplary embodiment, the two signal components evload_o and odload_o of the first control signal are triggered either by the leading edge or by the trailing edge of the clock signal, the static second control signal st_chg_clk_o, which is additionally generated by the controller SE, serves in each case to provide the second and first shift registers SR_ev, SR_od and the merging unit M with the information as to whether the leading or trailing edge of the clock signal clk_hr_i is to be taken for the data acceptance.

In the case of the synchronous parallel-serial converter described above with reference to FIGS. 1 to 4 and FIG. 7, it was assumed that the odd input data bits D1_od present in parallel at the first shift register SR_od over four bits and the even input data bits D1_ev present in parallel at the second shift register SR_ev over four bits were already present in separate form.

FIG. 10 shows a synchronous parallel-serial converter which is based on the synchronous parallel-serial converter from FIG. 1 but is functionally extended by comparison therewith and which additionally has a FIFO (first-in first-out) shift register, which is connected upstream of the first and second shift registers SR_od and SR_ev and to which an eight bit wide data input signal D1_in is written with a writing clock signal clk_or_fifowr_i (not explained any further at this juncture) and from which the odd four-bit data component and the even four-bit data component D1_ev are read out by means of a reading clock signal clk_or_fiford_i. The FIFO register FIFO accordingly serves as a synchronous data divider.

Consequently, the writing of the data to the FIFO register is synchronized with the writing clock clk_or_fifowr_i and the read-out of the data or the division thereof into the odd and even four data bits is synchronized with the reading clock clk_or_fiford_i. The writing clock and the reading clock present at the FIFO register belong to different clock domains, such that the reading clock clk_or_fiford is not necessarily synchronous with the writing clock clk_or_fifowr_i. It will be noticed that in the case of the synchronous parallel-serial converter illustrated in FIG. 10, the merging unit M has been omitted in order to simplify the illustration.

The third exemplary embodiment of the controller according to the invention, which embodiment is illustrated as a function block diagram in FIG. 11A, receives, in addition to the clock signal clk_hr_i and the reset signal rest_n_i to be described later, the first set signal st_load_I, to be precise two bits wide, like the first exemplary embodiment of the controller as shown in FIG. 5 and explained above, and a second set signal st_fiford_i likewise having a width of two bits, and registers them in the register means. The counting means in the controller SE in FIG. 11A are set up in such a way that they are triggered by the leading (trailing) edge of the clock signal clk_hr_i for generating the first control signal component evload_o and by the trailing (leading) edge of said clock signal for generating the second control signal component odload_o. Depending on a second two-bit set signal st_fiford_i registered in the register means, the controller SE generates a second control signal, that is the reading clock signal clk_or_fiford_i for the FIFO register, to be precise such that it is possible to set the phase angle thereof relative to the instant of the change in the data (that is the initial delay between the reset signal and the edges of clk_or_fiford_i).

If a delayed phase is generated by the controller SE for the FIFO read signal clk_or_fiford_i, this also influences the phase angle of the first and second control signal components evload_o and odload_o of the first control signal. These relationships and results for the absolute delay for the sampling instant in the shift register are illustrated in the table in FIG. 11B.

The signal timing diagrams in FIGS. 12A-12G illustrate that, depending on the registered first set signal st_load_i and the registered second set signal st_fiford_i, the counting means are set in such a way that the synchronization and output means output the second control signal, that is the FIFO reading clock signal clk_or_fiford_i, with a periodicity of four clock cycles, just like the periodicity of the first control signal, in the duty ratio 1:2 and in three positions that differ temporally in each case by one clock cycle, and the first control signal with the control signal components evload_o and odload_o having a fixed phase difference of half a clock period with respect to one another, in such a way that the phase difference between four successive position steps thereof is respectively one, one, two and two clock signal periods.

The synchronous parallel-serial converter illustrated in the function block diagram in FIG. 13 represents a combination of the synchronous parallel-serial converters that are respectively illustrated in FIGS. 7 and 10 and have already been described above, so that its functions extended by comparison with the synchronous parallel-serial converter shown in FIG. 1 need not be described again here.

In the same way, the function block diagram of the fourth exemplary embodiment of the controller SE according to the invention, which embodiment is illustrated in FIG. 14A, represents a combination of the above-described controllers illustrated in FIGS. 8A and 11A. As in the case of the controller SE illustrated in FIG. 8A, the first set signal st_load_i is fed in binary fashion with a width of three bits and registered in the register means, whereas, in a departure from the controller SE in FIG. 11A, the second set signal st_fiford_i is likewise fed with a width of three bits and registered in the register means.

On account of the first set signal st_load_i fed with a width of three bits and the second set signal st_fiford_i fed with a width of three bits, there are eight different binary values for the two set signals, said binary values being listed in the tabular representation in FIG. 14B. The two control signal components evload_o and odload_o of the first control signal are triggered both by the leading edge and by the trailing edge of the clock signal clk_hr_i. As a result, the controller SE generates, in addition to the second control signal or reading clock signal clk_or_fiford_i for the FIFO register, which signal is generated by the synchronization and output means with a periodicity of four clock cycles, a duty ratio 1:2 and in positions that differ temporally in each case by half a clock cycle, a third (static) control signal st_chgclk_o, which specifies an item of information as to whether the data are to be accepted, i.e. sampled, in the shift registers and in the merging unit M synchronously with the leading edge or with the trailing edge of the clock signal clk_hr_i.

In accordance with the signal timing diagrams illustrated in FIGS. 15A-15H, the fourth exemplary embodiment of the controller SE as shown in FIG. 14A generates the first control signal, that is to say the two signal components evload_o and odload_o thereof, in such a way that the phase difference between seven successive position steps thereof is respectively one half, one half, five halves, one half, five halves and one half of a clock signal period (also cf. the right-hand column in FIG. 14B).

The synchronous parallel-serial converter shown as a function block diagram in FIG. 16 corresponds to the above-described synchronous parallel-serial converter illustrated in FIG. 10, but has an extended functionality by comparison therewith in that the first shift register SR_od and the second shift register SR_ev are in each case fed a synchronous reset signal reset_n_i for resetting the counters and all storing components in the parallel-serial converter, excluding the register means.

Said synchronous reset signal reset_n_i is generated by the fifth exemplary embodiment of the controller SE according to the invention, which embodiment is shown as a function block diagram in FIG. 17, said controller for the rest being functionally identical to the third exemplary embodiment of the controller SE as illustrated in FIG. 11A. The controller SE in FIG. 17 receives, in addition to the clock signal clk_hr_i, the writing clock signal clk_or_fifowr_i, which controls the writing of the eight parallel data bits D1_in to the FIFO register in accordance with FIG. 16, an asynchronous reset signal areset_n_i. As set signals, the controller SE shown in FIG. 17 receives the first set signal st_load_i and the second set signal st_fiford_i, both as a binary two-bit signal, like the controller SE in accordance with FIG. 11A corresponding to the third exemplary embodiment. As control signals, the controller in FIG. 17 outputs the control signal components evload_o and odload_o of the first control signal and the second control signal, that is to say the FIFO reading clock signal clk_or_fiford_i, depending on the registered first and second set signals with a periodicity of four clock cycles, the duty ratio 1:2 and the four positions that differ temporally in each case by one clock period, and in a manner delayed by a specific number of clock cycles relative to the writing clock signal clk_or_fifowr_i. Moreover, the two control signal components evload_o and odload_o are generated the specific number of clock cycles after the FIFO reading clock signal clk_hr_i, depending on the first set signal st_load_i, in such a way that they can assume four temporally different positions (phase angles) which are shifted by one clock period in each case. Moreover, the controller SE in FIG. 17 outputs a reset signal reset n i which is synchronized with the clock signal clk_hr_i and which begins with the asynchronous reset signal areset_n_i but is oriented to the leading edge of the clock signal clk_hr_i and to the occurrence of the reading clock signal clk_or_fiford_i. This means that the synchronous reset signal reset_n_i must be switched off during the last half clock period of the clock signal clk_hr_i before the leading edge of the reading clock signal clk_or_fiford_i arrives.

The signal timing diagrams illustrated in FIGS. 18A-18C represent a selection of the signal waveforms during the occurrence of the reset signal and hence the function of the controller SE and the effect on the shift registers SR_od and SR_ev for different settings of the register means of the controller SE by means of the first and second set signals st_load_i and st_fiford_i.

The synchronous parallel-serial converter illustrated in the function block diagram in FIG. 19 represents a combination of the synchronous parallel-serial converters illustrated in FIGS. 13 and 16. For this reason, the sixth exemplary embodiment of the controller SE according to the invention, which embodiment is illustrated as a function block diagram in FIG. 20, is also a combination of the fourth exemplary embodiment illustrated in FIG. 14A with the fifth exemplary embodiment of the controller SE according to the invention as illustrated in FIG. 17.

Accordingly, the controller SE illustrated in FIG. 20 generates, in addition to the two signal components evload_o and odload_o of the first control signal, the second control signal or reading clock signal clk_or_fiford_i for the FIFO register and the synchronous reset signal reset_n_i, the static control signal st_chgclk_o, which depends on a registered value of the first set signal st_load_i present over three bits and specifies an item of information as to whether the two shift registers SR_od, SR_ev and the data merging unit M in accordance with FIG. 19 are to be synchronized with the leading or trailing edge of the clock signal clk_hr_i. It should be noted that in addition to the first set signal st_load_i registered as a three-bit binary signal in the register means of the controller SE, the second set signal st_fiford_i is likewise registered as a three-bit binary signal in the register means. Furthermore, it is important that the synchronous reset signal reset_n_i generated by the controller SE in FIG. 20 must be turned off during the last half cycle of the clock signal clk_hr_i before the leading edge or, in the case of the static control signal st_chgclk_o (=1), before the trailing edge of the reading clock signal clk_or_fiford_i.

The temporal relationships between the clock signal clk_hr_i, the writing clock signal clk_or_fifowr_i present at the controller SE, the asynchronous reset signal areset_n_i, the derived synchronous reset signal reset_n_i, the reading clock signal clk_or_fiford_i, the four-bit components of the input data D1_od and D1_ev and the two control signal components evload_o and odload_o of the first control signal which are respectively to be input to the first and second shift registers SR_od and SR_ev are illustrated in a selection in the signal timing diagrams illustrated in FIGS. 21A-21C depending on some combinations of the first set signal st_load_i and st_fiford_i and the static control signal st_chgclk_o derived therefrom. The synchronous reset signal reset_n_i generated with the fifth and sixth exemplary embodiments of the controller SE according to the invention, which reset signal provides for the temporally stable restart of the data acceptance or sampling of the four bit data in the shift registers of the synchronous parallel-serial converter, is generated by the controller SE in such a way that it is oriented synchronously to the leading edge of the clock signal clk_hr_i and to the occurrence of the FIFO reading clock signal clk_or_fiford_i.

### LIST OF REFERENCE SYMBOLS

1 Synchronous parallel-serial converter

SR_od First shift register

SR_ev Second shift register

M Merging unit

INV Inverting element

FIFO FIFO register

D1_od Odd component of the parallel input data

D1_ev Even component of the parallel input data

D2_od Odd serial data signal stream

D2_ev Even serial data signal stream

D3 Serial output data stream

odload_o First control signal component

evload_o Second control signal component

clk_hr_i Half-rate clock signal

sysclk System clock

SE Controller

st_load_i First set signal

reset_n_i Reset signal

st_chgclk_o Second (static) control signal

st_fiford_i Second set signal

clk_or_fiford_i FIFO reading clock signal

clk_or_fifowr_i FIFO writing clock signal

areset_n_i Asynchronous reset signal

What is claimed is:

1.-10. (canceled)

11. A controller for generating control signals synchronous with a continuous clock signal input to it for a device to be controlled synchronously with the clock signal, comprising:
synchronization and output system configured to synchronize a value counted by a counter with the clock signal and a registered set signal and outputting at least one of the control signal, wherein a register, the counter and the synchronization and output system are configured such that the output control signal(s), depending on a corresponding registered set signal, occupies one of a plurality of temporal positions with a respective phase difference of an integral multiple of half a clock cycle synchronously with a leading or trailing edge of the clock signal.

12. The controller of claim 11, comprising:
the register configured to register at least one set signal; and
the counter configured for counting edges of the clock signal depending on one or a plurality of set signals respectively registered in the register.

13. The controller of claim 12, comprising:
where the register is set up for registering at least one first set signal comprising n bit positions; and
where the counter is triggered by a leading or trailing edge of the clock signal, and are set by the respective registered value of at least the first set signal in such a way that the synchronization and output system outputs a first control signal with a first control signal component and a second control signal component, which has a fixed phase difference of half a clock cycle with respect to the first control signal component, and both control signal components with a periodicity of an integral multiple of the clock cycle and the duty ratio 1:4 in such a way that they can together occupy at least n2 different temporal positions synchronously with the clock signal.

14. The controller of claim 13, comprising wherein n=2, the periodicity of the first control signal is four clock cycles and the phase difference between four successive temporally different position steps thereof is in each case one clock cycle.

15. The controller of claim 13, comprising wherein n=3, the periodicity of the first control signal is four clock cycles and the phase difference between its eight temporally different positions is in each case half a clock cycle, and the synchronization and output are additionally set up for generating and outputting a static control signal which, depending on a registered value of the first set signal, specifies an item of information as to whether the device that is to be controlled by the controller and for this purpose receives the static control signal and the first and second control signal components of the first control signal is to be synchronized with the leading or trailing edge of the clock signal.

16. The controller of claim 13, comprising wherein the register is set up for registering a second set signal comprising two bit positions, n=2 and the periodicity of the first control signal is four clock cycles, wherein, depending on the registered first and second set signals, the counter is set in such a way that the synchronization and output output a second control signal with a periodicity of four clock cycles, the duty ratio 1:2 and in three positions that differ temporally in each case by one clock cycle, and the first control signal in such a way that the phase difference between four successive position steps thereof is respectively one, one, two, and two clock signal periods.

17. A controller for generating control signals synchronous with a continuous clock signal input to it for a device to be controlled synchronously with the clock signal, comprising:
a register for registering at least one set signal, comprising a plurality of bit positions;
a counter for counting edges of the clock signal depending on one or a plurality of set signals respectively registered in the register; and
synchronization and output system for synchronizing a value counted by the counter with the clock signal and the registered set signal and outputting at least one of the control signals, wherein the register, the counter and the synchronization and output system are configured and connected to one another in such a way that the output control signal(s), depending on the respectively registered set signal, occupies one of a plurality of temporal positions with a respective phase difference of an integral multiple of half a clock cycle synchronously with the leading or trailing edge of the clock signal.

18. The controller of claim 17, comprising:
the register is set up for registering at least one first set signal comprising n bit positions; and
the counter is triggered by the leading (trailing) edge of the clock signal and/or by the trailing edge of the clock signal, and are set by the respective registered value of at least the first set signal in such a way that the synchronization and output system output a first control signal with a first control signal component and a second control signal component, which has a fixed phase difference of half a clock cycle with respect to the first control signal component, and both control signal components with a periodicity of an integral multiple of the clock cycle and the duty ratio 1:4 in such a way that they can together occupy at least n2 different temporal positions synchronously with the clock signal.

19. The controller of claim 18, comprising wherein n=2, the periodicity of the first control signal is four clock cycles and the phase difference between four successive temporally different position steps thereof is in each case one clock cycle.

20. The controller of claim 18, comprising wherein n=3, the periodicity of the first control signal is four clock cycles and the phase difference between its eight temporally different positions is in each case half a clock cycle, and the synchronization and output are additionally set up for generating and outputting a static control signal which, depending on a registered value of the first set signal, specifies an item of information as to whether the device that is to be controlled by the controller and for this purpose receives the static control signal and the first and second control signal components of the first control signal is to be synchronized with the leading or trailing edge of the clock signal.

21. The controller of claim 18, comprising wherein the register is set up for registering a second set signal comprising two bit positions, n=2 and the periodicity of the first control signal is four clock cycles, wherein, depending on the registered first and second set signals, the counter is set in such a way that the synchronization and output system output a second control signal with a periodicity of four clock cycles, the duty ratio 1:2 and in three positions that differ temporally in each case by one clock cycle, and the first control signal in such a way that the phase difference between four successive position steps thereof is respectively one, one, two, and two clock signal periods.

22. The controller of claim 18, comprising wherein the register is set up for registering a second set signal comprising three bit positions, n=3 and the periodicity of the first control signal is four clock cycles, wherein, depending on the registered first and second set signals, the counter is set in such a way that the synchronization and output system outputs a second control signal with a periodicity of four clock cycles, the duty ratio 1:2 and in three positions that differ temporally in each case by half a clock cycle.

23. The controller of claim 18, comprising wherein the register is set up for registering a second set signal comprising two bit positions, n=2 and the periodicity of the first control signal is four clock cycles, and the controller additionally receives a continuous write signal, which is derived from the clock signal and is synchronous with the latter, with a periodicity of four clock cycles and also an asynchronous reset signal wherein the counter, depending on the registered first and second set signals, is set in such a way that the synchronization and output system outputs the first control signal in such a way that the phase difference between four temporally different positions thereof is in each case one clock period and a second control signal with a periodicity of four clock cycles, the duty ratio 1:2 and in four positions that differ temporally in each case by one clock period, and delayed by a respectively determined number of clock cycles with respect to the write signal, and also a reset signal synchronized with the clock signal, in such a way that its trailing edge coincides temporally with the asynchronous reset signal and its leading edge lies at least half a clock period before the leading edge of the second control signal.

24. The controller of claim 18, comprising wherein the register is set up for registering a second set signal comprising three bit positions, the bit number of the first set signal is n=3 and the periodicity of the first control signal is four clock cycles and the phase difference between the eight different time positions of the first control signal is in each case half a clock cycle, and the controller additionally receives a continuous write signal, which is derived from the clock signal and is synchronous with the latter, with a periodicity of four clock cycles and also an asynchronous reset signal, wherein the counter, depending on the registered first and second set signals, is set in such a way that the synchronization and output system outputs a second control signal with a periodicity of four clock cycles, the duty ratio 1:2 and relative to the phase of the write signal in eight different time positions that differ by in each case half a clock cycle, a reset signal which is synchronized with the clock signal and whose trailing edge coincides temporally with the asynchronous reset signal and whose leading edge lies at least half a clock period before the leading edge of the second control signal, and also a static control signal, which, depending on a registered value of the first set signal, specifies an item of information as to whether the device that is to be controlled by the controller and for this purpose receives the static control signal and the first and second control signals is to be synchronized with the leading or trailing edge of the clock signal.

25. The controller of claim 17, comprising wherein the register registers the set signal(s) synchronously with the clock signal.

26. The use of the controller of claim 17, for controlling a synchronous parallel-serial converter for converting a parallel input signal comprising k bit positions into a serial 1-bit output signal sequence synchronously with the clock signal, comprising:
a first shift register, which, synchronously with the trailing or leading edge of the clock signal, accepts an odd part of the k-bit input signal in parallel with the second control signal component and outputs it as a first serial 1-bit signal sequence;
a second shift register, which, synchronously with the leading or trailing edge of the clock signal, accepts an even part of the k-bit input signal with the first control signal component and outputs it as a second serial 1-bit signal sequence; and
a merging unit, which receives the first serial 1-bit signal sequence from the first shift register, the second serial 1-bit signal sequence from the second shift register and the clock signal and merges the first 1-bit signal sequence synchronously with the trailing or leading edge of the clock signal and the second 1-bit signal sequence synchronously with the leading or trailing edge of the clock signal to form the serial 1-bit output signal sequence and outputs the latter.

27. A controller for generating control signals synchronous with a continuous clock signal input to it for a device to be controlled synchronously with the clock signal, comprising:
a register means for registering at least one set signal, comprising a plurality of bit positions; a counter means for counting edges of the clock signal depending on one or a plurality of set signals respectively registered in the register; and
synchronization and output means for synchronizing a value counted by the counter with the clock signal and the registered set signal and outputting at least one of the control signals, wherein the register means, the counter means and the synchronization and output means are configured and connected to one another in such a way that the output control signal(s), depending on the respectively registered set signal, occupies one of a plurality of temporal positions with a respective phase difference of an integral multiple of half a clock cycle synchronously with the leading or trailing edge of the clock signal.

28. The controller of claim 27, comprising:
where the register means is set up for registering at least one first set signal comprising n bit positions; and
where the counter means is triggered by a leading or trailing edge of the clock signal, and are set by the respective registered value of at least the first set signal in such a way that the synchronization and output means outputs a first control signal with a first control signal component and a second control signal component, which has a fixed phase difference of half a clock cycle with respect to the first control signal component, and both control signal components with a periodicity of an integral multiple of the clock cycle and the duty ratio 1:4 in such a way that they can together occupy at least n2 different temporal positions synchronously with the clock signal.

29. The controller of claim 28, comprising wherein n=2, the periodicity of the first control signal is four clock cycles and the phase difference between four successive temporally different position steps thereof is in each case one clock cycle.

30. The controller of claim 28, comprising wherein n=3, the periodicity of the first control signal is four clock cycles and the phase difference between its eight temporally different positions is in each case half a clock cycle, and the synchronization and output means are additionally set up for generating and outputting a static control signal which, depending on a registered value of the first set signal, specifies an item of information as to whether the device that is to be controlled by the controller and for this purpose receives the static control signal and the first and second control signal components of the first control signal is to be synchronized with the leading or trailing edge of the clock signal.

31. A system comprising:
synchronization and output system configured to synchronize a value counted by a counter with the clock signal and a registered set signal and outputting at least one of the control signal, wherein a register, the counter and the synchronization and output system are configured such that the output control signal(s), depending on a corresponding registered set signal, occupies one of a plurality of temporal positions with a respective phase difference of an integral multiple of half a clock cycle synchronously with a leading or trailing edge of the clock signal; and
a device configured to receive the output control signals to be controlled synchronously with the clock signal.
